(19) United States
(12) Patent Application Publication
(10) Pub. No.: US 2025/0335607 A1
(43) Pub. Date: Oct. 30, 2025

(54) REQUIREMENT DOMAIN MAPPING FOR INFORMATION SECURITY AND PRIVACY COMPLIANCE

(71) Applicant: Insight Direct USA, Inc., Chandler, AZ (US)

(72) Inventor: Sayed Mansour Farani, Omaha, NE (US)

(21) Appl. No.: 18/651,054

(22) Filed: Apr. 30, 2024

(51) Int. Cl. G06F 21/60

(52) U.S. Cl. CPC G06F 21/60; G06F 2221/2101

(57) ABSTRACT

A governance, risk, and compliance (GRC) system includes a user interface, one or more processors, and computer-readable memory encoded with instructions. The instructions, when executed by the one or more processors, cause the GRC system to receive a client instruction indicating one or more applicable information security and/or privacy standards of pre-defined information security and/or privacy standards that include corresponding requirements and select a set of requirements according to the client instruction, access a domains map that associates the corresponding requirements with one or more domains, and generate a set of domain-mapped requirements. The instructions further cause the GRC system to access a question inventory, select applicable questions from the question inventory, generate a curated question set using the applicable questions, provide the curated question set to one or more users, receive responses to corresponding questions, and output recommendations based on the responses and the corresponding questions.

### BACKGROUND

The present disclosure relates generally to information security and privacy compliance, and more specifically to systems and methods for generating and administering information security and/or privacy compliance assessments.

Governance, risk (or risk management), and compliance (GRC) is a term that covers an organization's approach or strategy across its governance, risk management, and compliance practices. Businesses, organizations, and other entities have numerous compliance obligations, not only in the U.S. but across the globe. Many laws and regulations define corporate or government compliance requirements for these entities, such as in the areas of information security and privacy. The laws and regulations can vary by country and industry or sector. Entities review applicable laws and regulations or other guidance to determine their level of compliance and implement controls. Entities may also undergo audits or assessments to ascertain their current compliance posture.

### SUMMARY

In one example, a governance, risk, and compliance (GRC) system includes a user interface, one or more processors, and computer-readable memory encoded with instructions. The instructions, when executed by the one or more processors, cause the GRC system to receive a client instruction indicating one or more applicable cybersecurity standards of pre-defined cybersecurity standards, each of the pre-defined cybersecurity standards including corresponding requirements. The instructions further cause the GRC system to select a set of requirements associated with the one or more applicable cybersecurity standards according to the client instruction. The instructions further cause the GRC system to access, from a computer-based library, a domains map that associates the corresponding requirements of the pre-defined cybersecurity standards with one or more domains and generate a set of domain-mapped requirements based on corresponding domains of the set of requirements associated with the one or more applicable cybersecurity standards according to the domains map. The instructions further cause the GRC system to access a question inventory from the computer-based library, select applicable questions from the question inventory based on each requirement of the set of domain-mapped requirements, and generate a curated question set using the applicable questions. The instructions further cause the GRC system to provide the curated question set to one or more users via the user interface, receive responses to corresponding questions of the curated question set from the one or more users, and update a response field of a linked question of the curated question set concurrently in response to receiving a first response for a first question of the curated question set that is linked to the linked question. The instructions further cause the GRC system to output recommendations based on the responses and the corresponding questions of the curated question set.

In another example, a method of generating and administering an information security and/or privacy assessment includes receiving a client instruction indicating one or more applicable cybersecurity standards of pre-defined cybersecurity standards, each of the pre-defined cybersecurity standards including corresponding requirements. The method further includes selecting a set of requirements associated with the one or more applicable cybersecurity standards according to the client instruction. The method further includes accessing, from a computer-based library, a domains map that associates the corresponding requirements of the pre-defined cybersecurity standards with one or more domains and generating a set of domain-mapped requirements based on corresponding domains of the set of requirements associated with the one or more applicable cybersecurity standards according to the domains map. The method further includes accessing a question inventory from the computer-based library, selecting applicable questions from the question inventory based on each requirement of the set of domain-mapped requirements, and generating a curated question set using the applicable questions. The method further includes providing the curated question set to one or more users via a user interface, receiving responses to corresponding questions of the curated question set from the one or more users, and updating a response field of a linked question of the curated question set concurrently in response to receiving a first response for a first question of the curated question set that is linked to the linked question. The method further includes outputting recommendations based on the responses and the corresponding questions of the curated question set.

In another example, a system for generating and administering an information security and/or privacy assessment includes a user interface, one or more processors, and computer-readable memory encoded with instructions. The instructions, when executed by the one or more processors, cause the system to receive a client instruction indicating one or more applicable information security and/or privacy standards of pre-defined information security and/or privacy standards, each of the pre-defined information security and/or privacy standards including corresponding requirements. The instructions further cause the system to select a set of requirements associated with the one or more applicable information security and/or privacy standards according to the client instruction. The instructions further cause the system to access, from a computer-based library, a domains map that associates the corresponding requirements of the pre-defined information security and/or privacy standards with one or more domains and generate a set of domain-mapped requirements based on corresponding domains of the set of requirements associated with the one or more applicable information security and/or privacy standards according to the domains map. The instructions further cause the system to access a question inventory from the computer-based library, select applicable questions from the question inventory based on each requirement of the set of domain-mapped requirements, and generate a curated question set using the applicable questions. The instructions further cause the system to provide the curated question set to one or more users via the user interface, receive responses to corresponding questions of the curated question set from the one or more users, and update a response field of a linked question of the curated question set concurrently in response to receiving a first response for a first question of the curated question set that is linked to the linked question. The instructions further cause the system to output recommendations based on the responses and the corresponding questions of the curated question set.

### BRIEF DESCRIPTION OF THE DRAWINGS

FIG. 1 is a schematic block diagram illustrating a GRC system including a GRC tool.

FIG. 2 is a schematic block diagram illustrating relationships between a library and modules of the GRC tool.

FIG. 3 is a schematic block diagram illustrating details of a standards module of the GRC tool.

FIG. 4 is a schematic block diagram illustrating details of a dependency mapping module of the GRC tool.

FIG. 5 is a schematic block diagram illustrating details of a domain mapping module of the GRC tool.

FIG. 6 is a schematic block diagram illustrating details of an operational definition module of the GRC tool.

FIG. 7A is a schematic block diagram illustrating details of a client response module of the GRC tool.

FIG. 7B is a schematic block diagram illustrating an overall question set including domain-mapped subset question sets as inputs to the client response module of the GRC tool.

FIG. 8 is a schematic block diagram illustrating concurrent updates for linked questions of an overall question set.

FIG. 9 is a schematic block diagram illustrating details of a recommendations module of the GRC tool.

FIG. 10 is a process flowchart showing steps of a first example of a process for generating and administering an information security and/or privacy assessment.

FIG. 11 is a process flowchart showing steps of a second example of a process for generating and administering an information security and/or privacy assessment.

FIG. 12 is a process flowchart showing steps of a third example of a process for generating and administering an information security and/or privacy assessment.

### DETAILED DESCRIPTION

Organizations can be subject to numerous information security and/or privacy laws and regulations but often lack a strategic approach to implementing controls or handling audits or assessments of the organization's current information security and/or privacy compliance posture. The complexity of the external regulatory environment can be a primary driver for an organization to implement a strategic approach to GRC initiatives. Without a strategic approach, organizations can end up in highly inefficient engagements where isolated silos within the organization are essentially operating on their own and each silo inevitably creates its own redundancies. One major issue is the risk of “audit fatigue,” where auditors make redundant requests to different teams and there is no consistency between the auditors or teams. Due to the complexity of the external regulatory environment, organizations may also struggle to implement a GRC strategic approach manually. Thus, organizations need the right tools for implementing a GRC strategic approach. However, existing tools have several limitations, both in the product and in that existing tools tend to be heavily product-focused without a corresponding service aspect.

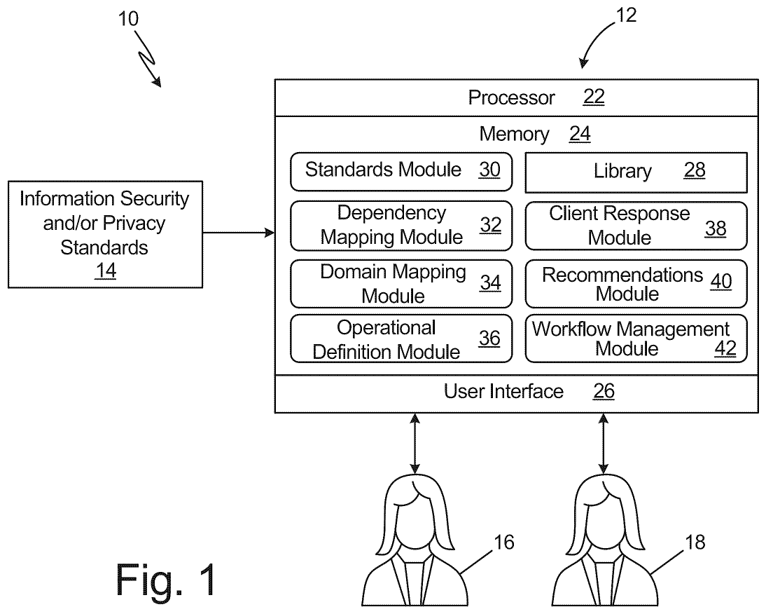

A GRC system according to techniques of this disclosure includes a GRC tool that breaks down information security and/or privacy requirements into questions that represent operational definitions of the requirements for more objective and consistent assessments, identifies dependencies between information security and/or privacy requirements for more consistent assessments, and groups information security and/or privacy requirements into domains to improve planning, compliance monitoring, and control implementation within a client organization. The GRC system, including the GRC tool, and corresponding methods will be described below with reference to FIGS. 1-12.

FIG. 1 is a schematic block diagram illustrating GRC system 10 including GRC tool 12. As shown in FIG. 1, GRC system 10 includes GRC tool 12, information security and/or privacy standards 14 (also referred to herein as “standards 14” for simplicity), client 16, and assessor 18. GRC tool 12 includes processor 22, memory 24, and user interface 26. GRC tool 12 further includes library 28, standards module 30, dependency mapping module 32, domain mapping module 34, operational definition module 36, client response module 38, recommendations module 40, and workflow management module 42.

GRC system 10 can be implemented as part of an organization's or other entity's GRC initiative with respect to information security and/or privacy. As illustrated in FIG. 1, GRC system 10 can include one or more clients 16 and one or more assessors 18 trained to utilize GRC tool 12 within GRC system 10. GRC system 10 also includes GRC tool 12 and standards 14.

Standards 14 are existing or predefined (i.e., defined outside of or separately from GRC tool 12) information security (including cybersecurity) and/or privacy standards, such as based on laws or regulations, that define corporate or government compliance requirements for organizations or other entities. These standards can vary by state, country, and industry or sector. According to some assessments, approximately 80-90% of organizations are subject to four or more information security and/or privacy standards.

Typically, information security and privacy standards are framework-based, and the frameworks are published by authoritative sources. Several non-limiting examples of standards 14 include the National Institute of Standards and Technology (NIST) Cybersecurity Framework (CSF), the Payment Card Industry Data Security Standard (PCI DSS), the HITRUST CSF, the Control Objectives for Information and Related Technologies (COBIT) framework created by ISACA, International Organization for Standardization/International Electrotechnical Commission (ISO/IEC) 27001, the Center for Internet Security (CIS) Critical Security Controls, the Federal Information Security Management Act (FISMA), the California Consumer Privacy Act (CCPA), the General Data Protection Regulation (GDPR), the Sarbanes-Oxley Act (SOX), and the Health Insurance Portability and Accountability Act (HIPAA). Standards 14 can be accessed, stored, and used or referenced by GRC tool 12. In some examples, standards 14 or data representing standards 14 can be imported into GRC tool 12 (e.g., to be stored in library 28). In some examples, GRC tool 12 can access an authoritative source of one or more of standards 14 directly. In other examples, standards 14 or data representing standards 14 can be imported into GRC tool 12 manually.

GRC tool 12 is a computer-based tool or platform for carrying out the functionality described herein to generate and administer information security and/or privacy compliance assessments. GRC tool 12 can take the form of one or more computers, each including a processor and memory. In some examples, GRC tool 12 can be implemented as a dedicated computer. In other examples, GRC tool 12 can be implemented on a computer that makes up part of a user device, such as a desktop computer, a laptop, a smartphone, a tablet, or any other similar device. That is, GRC tool 12 can include dedicated hardware or can include software that runs on client hardware. In some examples, GRC tool 12 can be embodied in a mobile application that is downloaded to a user device and runs on the user device. In other examples, GRC tool 12 can include a browser-based application that runs within an internet browser (for accessing websites on the World Wide Web or a local network, including any internet browser that is available on the market, such as Google Chrome, Microsoft Edge, Firefox, Safari, etc., or a custom browser) on a user device. In any such examples, GRC tool 12 can also include a web server (not shown) for distributing code to the application, which may include running an application programming interface (API) to connect to mobile applications. In yet other examples, GRC tool 12 can be implemented as a wholly or partially cloud-based tool, with components that are remote from each other and available via cloud services from vendors such as Amazon, Microsoft, Google, or others.

GRC tool 12 includes processor 22, memory 24, and user interface 26. Although processor 22 and memory 24 are illustrated in FIG. 1 as being separate components of a single computer device, it should be understood that in other examples, processor 22 and memory 24 can be distributed among multiple connected devices. In other examples, memory 24 can be a component of processor 22. Processor 22 is configured to implement functionality and/or process instructions within GRC tool 12. For example, processor 22 can be capable of processing instructions stored in memory 24. Examples of processor 22 can include one or more of a processor, a microprocessor, a controller, a digital signal processor (DSP), an application specific integrated circuit (ASIC), a field-programmable gate array (FPGA), or other equivalent discrete or integrated logic circuitry.

Memory 24 can be configured to store information before, during, and/or after operation of GRC tool 12. Memory 24, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 24 can be entirely or partly temporary memory, meaning that a primary purpose of memory 24 is not long-term storage. Memory 24, in some examples, is described as volatile memory, meaning that memory 24 does not maintain stored contents when power to devices (e.g., hardware of GRC tool 12) is turned off. Examples of volatile memories can include random access memories (RAM), dynamic random access memories (DRAM), static random access memories (SRAM), and other forms of volatile memories. Memory 24, in some examples, also includes one or more computer-readable storage media. Memory 24 can be configured to store larger amounts of information than volatile memory. Memory 24 can further be configured for long-term storage of information. In some examples, memory 24 includes non-volatile storage elements. Examples of such non-volatile storage elements can include magnetic hard discs, optical discs, flash memories, or forms of electrically programmable memories (EPROM) or electrically erasable and programmable (EEPROM) memories.

Memory 24 is encoded with instructions that are executed by processor 22. For example, memory 24 can be used to store program instructions for execution by processor 22. In some examples, memory 24 is used by software or applications running on processor 22 to temporarily store information during program execution.

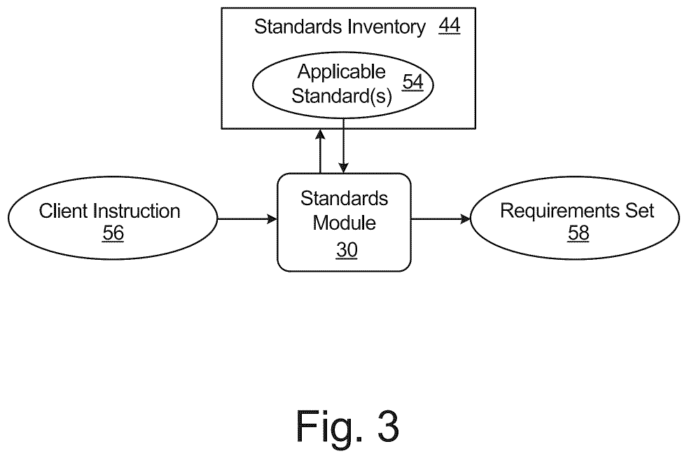

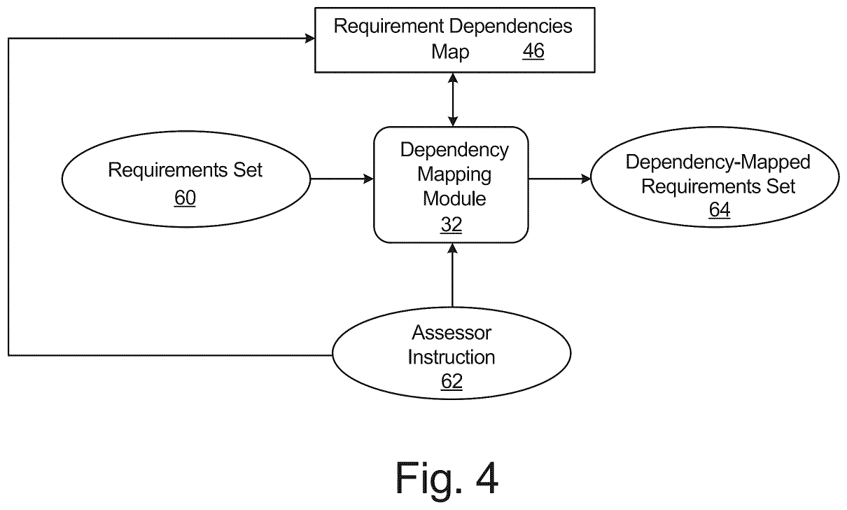

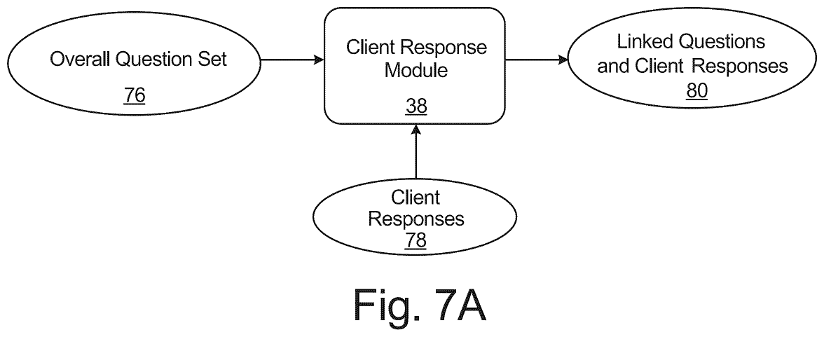

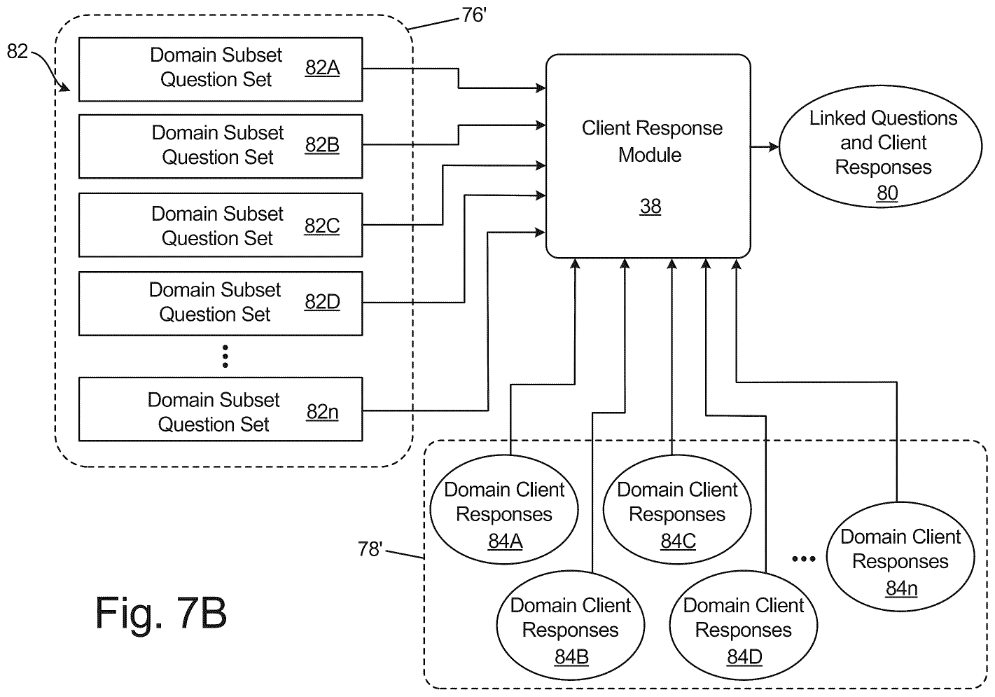

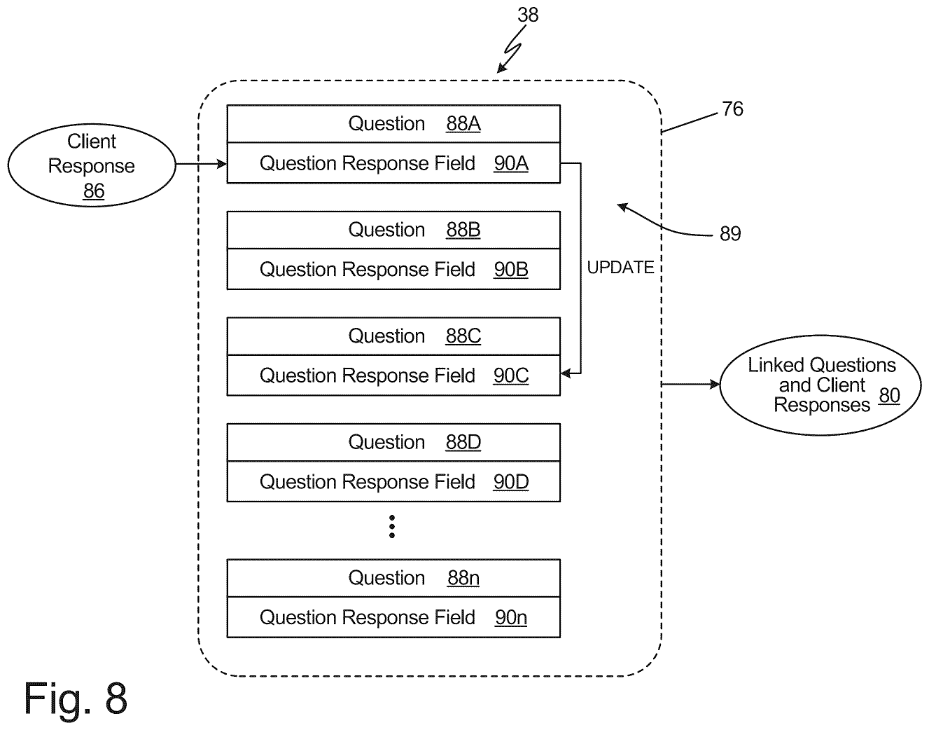

User interface 26 can be included as part of GRC tool 12 to allow users, such as client 16 and assessor 18, to interact with GRC tool 12 in GRC system 10. User interface 26 can include graphical and/or physical control elements that enable user input to interact with GRC tool 12. In some examples, user interface 26 includes a display, such as a liquid crystal display (LCD), a light-emitting diode (LED) display, an organic light-emitting diode (OLED) display, or other display device suitable for providing information to users in visual form. In some examples, user interface 26 can take the form of a graphical user interface (GUI) that presents graphical control elements presented at, e.g., a touch-sensitive and/or presence sensitive display screen. In such examples, user input can be received in the form of gesture input, such as touch gestures, scroll gestures, zoom gestures, or other gesture input. In certain examples, user interface 26 can take the form of and/or include physical control elements, such as a physical buttons, keys, knobs, or other physical control elements configured to receive user input to interact with GRC tool 12. User interface 26 can allow client 16 to input instructions (e.g., as will be described in greater detail below with reference to FIG. 3), review information associated with standards 14, and input responses (e.g., as will be described in greater detail below with reference to FIGS. 7A-8), for example. Additionally, user interface 26 can allow assessor 18 to configure aspects of GRC tool 12, such as by modifying requirements, questions, and recommendations that are generated by GRC tool 12 (e.g., as will be described in greater detail below with reference to FIGS. 4-6 and 9), and to review responses from client 16.

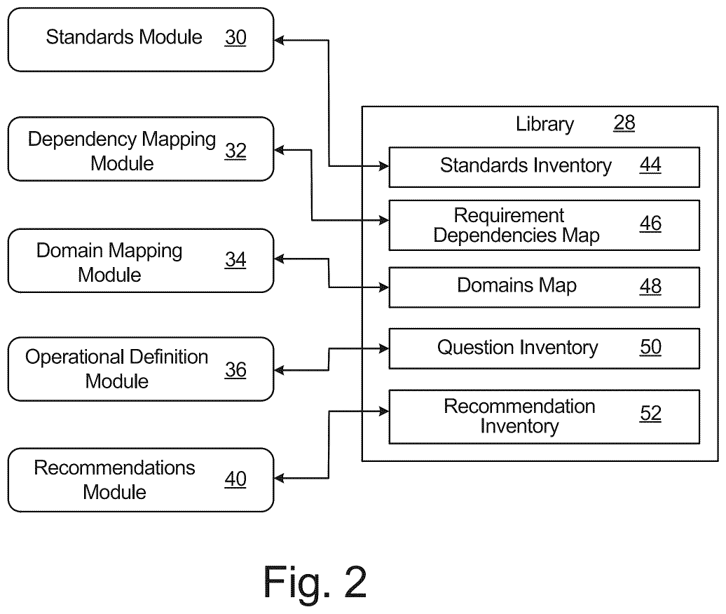

As illustrated in FIG. 1, GRC tool 12 includes library 28. Library 28 includes information usable within GRC tool 12 by various functional modules, as will be described in greater detail below, particularly with reference to FIG. 2. Although library 28 is illustrated in memory 24 in FIG. 1, in alternate examples, library 28 could also be accessible by GRC tool 12 from an external data store rather than from local memory. For example, library 28 could be stored in a remote and/or cloud data store or on one or multiple other devices. More generally, library 28 can be stored in any data store that is suitable for storing electronic data in an organized manner, such as in a database or an Excel spreadsheet, to name a few, non-limiting examples.

GRC tool 12 can be further defined as a set of functional modules. Although the functionality of GRC tool 12 is described herein as being divided into seven modules, it should be understood that the functionality of GRC tool 12 could also be described as more or fewer modules, which could depend, in some examples, on how code is written or organized. As illustrated in FIG. 1, GRC tool 12 includes standards module 30, dependency mapping module 32, domain mapping module 34, operational definition module 36, client response module 38, recommendations module 40, and workflow management module 42. Standards module 30, dependency mapping module 32, domain mapping module 34, operational definition module 36, client response module 38, recommendations module 40, and workflow management module 42 will generally be described sequentially herein; however, these modules need not always be performed in any particular order and may also include overlapping or interspersed functionality.

Standards module 30 is a first functional module of GRC tool 12. Standards module 30 includes methods in code for accessing stored standards 14 and selecting requirements associated with standards 14. Standards module 30 will be described in greater detail below with reference to FIG. 3.

Dependency mapping module 32 is a second functional module of GRC tool 12. Dependency mapping module 32 includes methods in code for mapping dependencies of requirements associated with standards 14. Dependency mapping module 32 will be described in greater detail below with reference to FIG. 4.

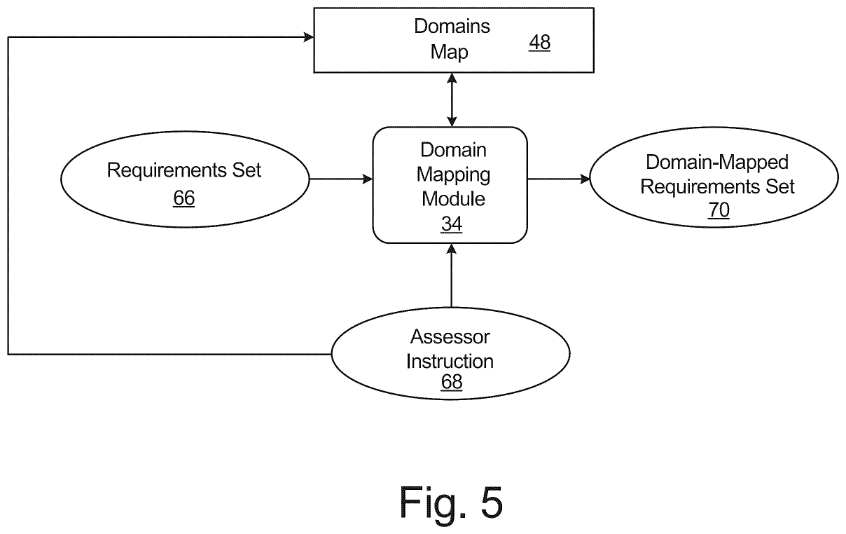

Domain mapping module 34 is a third functional module of GRC tool 12. Domain mapping module 34 includes methods in code for organizing requirements associated with standards 14 into groups based on domains. Domain mapping module 34 will be described in greater detail below with reference to FIG. 5.

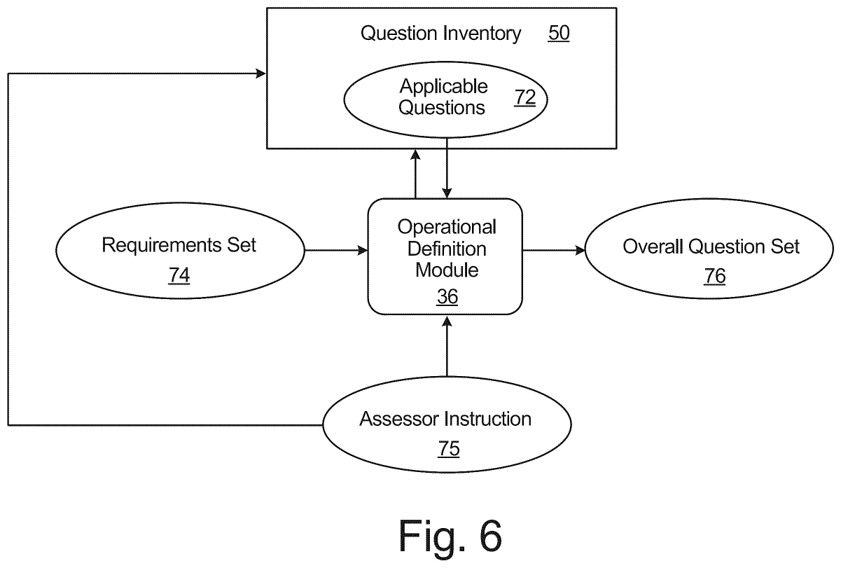

Operational definition module 36 is a fourth functional module of GRC tool 12. Operational definition module 36 includes methods in code for breaking requirements associated with standards 14 into questions representing operational definitions. Operational definition module 36 will be described in greater detail below with reference to FIG. 6.

Client response module 38 is a fifth functional module of GRC tool 12. Client response module 38 includes methods in code for providing questions to client 16 and receiving responses from client 16. Client response module 38 will be described in greater detail below with reference to FIGS. 7A-8.

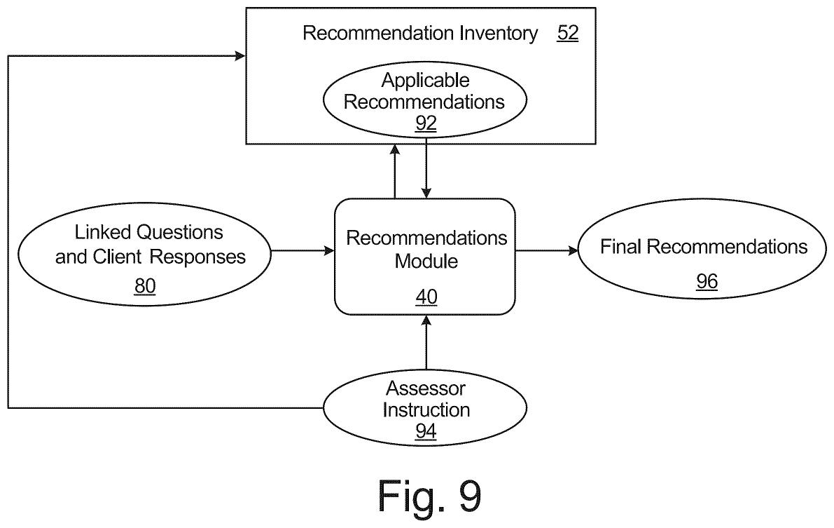

Recommendations module 40 is a sixth functional module of GRC tool 12. Recommendations module 40 includes methods in code for associating recommendations with questions and client responses. Recommendations module 40 will be described in greater detail below with reference to FIG. 9.

Workflow management module 42 is a seventh functional module of GRC tool 12. Workflow management module 42 includes methods in code for workflow functions associated with GRC tool 12. Generally, workflow management module 42 can access or receive information from other modules of GRC tool 12 and organize or convert that information into a form that can be readily presented to users via user interface 26. In some examples, workflow management module 42 can automatically create user dashboards with applicable tasks, notifications, etc. for one or more users (e.g., clients 16 and assessors 18). User dashboards created by workflow management module 42 can include action items that are specific to particular groups of users, such as particular domains, as will be described in greater detail below with reference to FIG. 7B. In some examples, workflow management module 42 generates notifications or alerts, messages (such as emails), and reports, which can be directed to one or more users (e.g., clients 16 and assessors 18) of GRC tool 12. For example, workflow management module 42 can assign a task to client 16 with options for client 16 to mark the task as accepted, rejected, mitigated, etc. In another example, workflow management module 42 can generate an alert for client 16 and/or assessor 18, such as to indicate incomplete tasks. In yet another example, workflow management module 42 can generate a report of activities in GRC tool 12 for client 16 (e.g., for one or more domains) and/or assessor 18 to summarize information such as existing practices, any deficiencies, recommendations, etc.

Compared to existing tools for aiding organizations in implementing a GRC strategic approach, GRC system 10 incorporates both an improved product in the form of GRC tool 12 and an improved service based on the capacity within GRC system 10 for facilitating interaction between client 16 and assessor 18 via GRC tool 12. GRC tool 12 can reduce the resources (e.g., time, labor, cost, etc.) that an organization must spend to implement a GRC strategic approach, and, in particular, to undergo an audit in this area. For example, starting from scratch to compile the relevant information from applicable information security and/or privacy standards, develop an assessment based on the compiled information, carry out the assessment, and organize and understand the results of the assessment might be expected to take an organization over half a year (or about six to nine months). The timeframe for a similar process using GRC tool 12 can be significantly reduced, and, in some examples, might only be around six weeks to three months or potentially even shorter.

GRC tool 12 also allows for more objective and consistent assessments of information security and/or privacy compliance and can improve planning, compliance monitoring, and control implementation within a client organization. Accordingly, assessments generated and administered by GRC tool 12 can help to reduce “audit fatigue” for an organization undergoing audits. Overall, assessments generated and administered by GRC tool 12 can be more effective for assessing a client organization's information security and/or privacy compliance, and GRC tool 12 can serve as an integral piece of the client organization's GRC strategic approach. Moreover, GRC tool 12 can be left behind with the client organization so the client organization can continue to monitor its compliance posture.

FIG. 2 is a schematic block diagram illustrating relationships between library 28 and modules of GRC tool 12. FIG. 2 shows library 28, standards module 30, dependency mapping module 32, domain mapping module 34, operational definition module 36, and recommendations module 40. As shown in FIG. 2, library 28 includes standards inventory 44, requirement dependencies map 46, domains map 48, question inventory 50, and recommendation inventory 52.

As illustrated in FIG. 2, library 28 includes a collection of separate libraries, including standards inventory 44, requirement dependencies map 46, domains map 48, question inventory 50, and recommendation inventory 52. Each of standards inventory 44, requirement dependencies map 46, domains map 48, question inventory 50, and recommendation inventory 52 can be stored separately or can be a conceptual representation of a portion of library 28. Additionally, library 28 (or any of standards inventory 44, requirement dependencies map 46, domains map 48, question inventory 50, and recommendation inventory 52) can receive updates, such as when there are changes to standards 14, changes in what is considered best practices for a certain industry, etc.

As described above, standards 14, or data representing standards 14, are imported into GRC tool 12 and can be stored in standards inventory 44 of library 28. Accordingly, standards inventory 44 can be considered a collection of standards 14. Each of standards 14 can be broken down into corresponding individual requirements. In some examples, standards inventory 44 can include all or a portion of standards 14 in a crosswalk format that indicates the alignment or overlap of requirements between different ones of information security and/or privacy standards 14 (e.g., the alignment of NIST CSF requirements to ISO/IEC requirements, etc.). According to some assessments, the amount of overlap between ones of standards 14 can be around 30-60% and up to about 92% in the specific example of NIST CSF and ISO/IEC requirements. When standards 14 are stored in crosswalk format in standards inventory 44, overlapping, matching, or redundant requirements between different ones of standards 14 may be linked or, alternatively, may only be stored once as a combined requirement of all corresponding ones of standards 14. As such, having standards 14 stored in crosswalk format in standards inventory 44 can improve the baseline efficiency of developing a GRC audit or assessment using GRC tool 12 because at least some redundancies are mitigated, and additional mapping in library 28 (e.g., in requirement dependencies map 46, domains map 48, and question inventory 50 described below) further improves efficiency from that baseline. Crosswalk formats of standards 14 may be generated from existing systems or tools, e.g., using artificial intelligence natural language processing and/or human analysis and validation to map the requirements, and stored in standards inventory 44.

Standards inventory 44 includes standards 14 in a form that is divided into the corresponding individual requirements of each information security and/or privacy standard. For example, NIST CSF is divided at the highest level into five functions, including “Identify,” “Protect,” “Detect,” “Respond,” “and “Recover,” each of which is assigned a corresponding unique identifier (“ID,” “PR,” “DE,” “RS,” and “RC,” respectively). Within each function are several categories, which are also given corresponding unique identifiers (e.g., the category “Asset Management” in the “Identify” function has the unique identifier “ID.AM”). Categories are further divided into sub-categories, which are identified by the category unique identifier and a number (e.g., the first sub-category in ID.AM is identified as “ID.AM-1”). Other standards 14 can have similar hierarchical or framework-based organizations of individual requirements. In some examples, standards inventory 44 includes an identification (ID) for each individual requirement of the one or more standards 14. The ID can be any unique identifier, such as a combination of letters and/or numbers, and, in some examples, can be an identifier that is also used in the authoritative source of the respective standard. The individual requirements in standards inventory 44 can be associated with the entire text of the respective requirement, or standards inventory 44 may only include the ID for each individual requirement. In some examples, the individual requirement IDs in standards inventory 44 can also be linked (e.g., by website addresses) to other sources of standards 14, such as authoritative sources, which may include the most up to date version of the corresponding requirement language. As illustrated in FIG. 2, standards module 30 accesses standards inventory 44 to obtain information from standards inventory 44, such as individual requirement IDs.

Library 28 also includes requirement dependencies map 46. Requirement dependencies map 46 stores dependencies, or relationships, between requirements of standards 14. There can be any number of dependencies between any number of requirements stored in requirement dependencies map 46. The dependencies can also be at any level within a hierarchy of one of standards 14 (e.g., for NIST CSF, dependencies can be at the category or sub-category level). Dependencies stored in requirement dependencies map 46 define and represent or indicate that one or more requirements of standards 14 are dependent on another, higher order requirement of standards 14. There can be any number of sets of dependent and higher order requirements stored in requirement dependencies map 46.

The one or more dependent requirements are a function of the corresponding higher order requirement, meaning that information relevant to the higher order requirement is also relevant to any dependent requirement. That is, the one or more dependent requirements are not necessarily matching or opposite requirements compared to the higher order requirement but rather can have some other relationship to the higher order requirement. For example, one of standards 14 could include a first requirement for data classification that sensitive data is identified and a second requirement that sensitive data is encrypted. In this example, these requirements are related, or dependent, in that it would not make sense to determine for the first requirement that sensitive data is not identified but then to determine for the second requirement that sensitive data is encrypted (because if the sensitive data is not identified then it cannot have been encrypted). On the other hand, it could make sense to determine for the first requirement that sensitive data is identified but then to determine for the second requirement that sensitive data is not encrypted. Any other similar types of relationships between requirements of standards 14 can also be represented in requirement dependencies map 46.

Individual requirements of standards 14 can be linked in requirement dependencies map 46 to dependent requirements (i.e., any requirements that are dependent on the respective requirement and any requirements that the respective requirement is dependent from). In one example, requirement dependencies map 46 can be organized in linked tables that include requirement IDs for dependent requirements. In other examples, requirement dependencies map 46 can be any suitable data structure capable of organizing data (i.e., dependency information) such that relationships between the data are maintained. As illustrated in FIG. 2, dependency mapping module 32 accesses requirement dependencies map 46 to obtain information from requirement dependencies map 46.

Library 28 also includes domains map 48. Domains map 48 stores associations of requirements of standards 14 with one or more domains or sub-domains, both of which are generally referred to herein as “domains,” except where specifically indicated. Each domain can represent a functional and/or decision-making division within an organization. For example, each domain can represent a functional and/or decision-making division with respect to GRC initiatives for an organization. More generally, the one or more domains are high-level categories for organizing individual requirements of standards 14. In some examples, the domains are generic to each of standards 14 (i.e., requirements of each of standards 14 can be organized into the same domains). Domains map 48 can include any number of domains and any number of requirements organized into the domains. In some examples, domains map 48 includes about 15-20 domains. Some non-limiting examples of domains include a GRC strategy domain, a policy management domain, a prioritization and classification of environments domain, a risk management program domain, a security awareness program domain, a third-party management domain, a change management domain, a secure software development life cycle (SDLC) domain, a vulnerability management domain, an end-point protection/anti-malware domain, a contingency planning domain, a security audit log management domain, an identity and access management domain, a physical security domain, a data governance program domain, an infrastructure/network security domain, an incident response domain, and a regular audit domain, among other possible domains.

In some examples, one or more of the domains in domains map 48 are subdivided into respective sub-domains. Accordingly, sub-domains also represent functional and/or decision-making divisions within an organization, such as with respect to GRC initiatives, but sub-domains can be relatively more specific divisions that are organized under a higher-level domain. For example, a vulnerability management domain could be subdivided into sub-domains, including an asset management sub-domain, an information technology (IT) asset classification sub-domain, a configuration management sub-domain, a patch management sub-domain, a scanning and penetration testing sub-domain, and a secondary sources sub-domain. Alternatively, these sub-domains could be categorized in domains map 48 as domains rather than sub-domains, with or without a distinct vulnerability management domain. In another example, a data governance program domain could also be subdivided into sub-domains, including a data discovery classification and labeling sub-domain, a data purging sub-domain, and an encrypt data at-rest and in-transit sub-domain. Alternatively, these sub-domains could be categorized in domains map 48 as domains rather than sub-domains, with or without a distinct data governance program domain. More generally, domains map 48 can include any number of domains, any number of which can further include any number of sub-domains, and any number of requirements can be organized into the domains and sub-domains. In other examples, domains map 48 may not include any sub-domains.

Within domains map 48, “alike” requirements of standards 14 are grouped into domains. For example, requirements relating to asset management can be grouped into an asset management domain (or sub-domains). Individual requirements of standards 14 that belong to a particular domain are generally associated with downstream action items that would fall under the scope of the same group or team within an organization. For example, a risk management program domain can correspond to a risk management program team in an organization, which will be responsible for implementing action items dictated by the requirements that belong to the risk management program domain. In some examples, individual requirements of standards 14 only impact or belong to a single domain. In other examples, individual requirements of standards 14 impact or belong to more than one domain.

As such, individual requirements of standards 14 can be linked in domains map 48 to one or more domains. For example, each domain can have a unique ID (similar to requirement IDs) represented in domains map 48, and requirement IDs for individual requirements of standards 14 can be associated with corresponding domain IDs for domains that contain the respective requirements. In one such example, domains map 48 can be organized in lists or tables that include requirement IDs and corresponding domain IDs (or vice versa). In other examples, domains map 48 can be any suitable data structure capable of organizing data (i.e., domains information) such that relationships between the data are maintained. As illustrated in FIG. 2, domain mapping module 34 accesses domains map 48 to obtain information from domains map 48.

Library 28 also includes question inventory 50. Question inventory 50 stores operational definitions of individual requirements of standards 14. That is, each individual requirement of standards 14 is broken down in question inventory 50 into more objective questions for defining the respective requirement, which, taken together, represent an operational definition of the respective requirement. Each individual requirement of standards 14 can correspond to any number of questions in question inventory 50. For example, some requirements may only be broken into a few corresponding questions, whereas other requirements may have five, ten, or more corresponding questions. In some examples, the questions (and the operational definitions) in question inventor 50 can have been developed from supplementation information that is available from the authoritative sources of standards 14. In general, the questions the represent an operational definition for a respective requirement of standards 14 are formulated to make the respective requirement more quantitative or measurable (i.e., to reduce the subjectivity in responding to or implementing the requirement).

For example, within the “Asset Management” category of NIST CSF, one sub-category (“ID.AM-1”) states that “Physical devices and systems within the organization are inventoried.” NIST CSF does not include further levels in the hierarchy to define what “inventoried” means or what can be classified as “physical devices and systems,” for example. However, in question inventory 50, this requirement can be broken down into several more objective and quantifiable questions, such as: “How is the inventory put together?”; “Does the inventory use automated or manual tools?”; “Do you run any inventory scans, and, if so, how often?”; “What information is in your inventory list?”; “What is the ID of each IT asset in your inventory?”; or any other questions. In another example, another NIST CSF sub-category (“ID.RA-1”) states that “Asset vulnerabilities are identified and documented.” Like with the previous example, question inventory 50 could include several more objective and quantifiable questions that correspond to this requirement, such as: “Do you have a vulnerability management committee?”; “What are some of the primary responsibilities of the vulnerability management committee?”; “What does the vulnerability management committee oversee?”; “How and how often do you patch your systems?”; or any other questions. Requirements of other standards 14 can be similarly broken down into more objective and quantifiable questions in question inventory 50.

Question inventory 50 can, in some examples, include an exhaustive list of questions associated with each requirement of standards 14. In this way, question inventory 50 can also be described as including both a baseline set of questions as well as optional questions for each requirement of standards 14. The baseline questions can be generic questions that are applicable to all (or almost all) organizations that use GRC tool 12. The optional questions can be formulated to cover any number of specific client circumstances that may not be generally applicable to all organizations that use GRC tool 12. In some examples, question inventory 50 can include multiple iterations of the same (or nearly the same) question, each iteration being associated with a different requirement of standards 14. In some examples, questions in question inventory 50 can also be associated with indications (e.g., with a metadata tag) of corresponding information for the respective question, such as applicable domains, reference materials, sources, question weighting, etc. For example, one or more questions in question inventory 50 can be weighted, e.g., to indicate relative importance of the question in determining overall compliance of the client organization. The weighting can be based on a simple multiplier for low or high importance or can be more complex.

Each individual requirement of standards 14 can be linked to one or more corresponding questions in question inventory 50. For example, each question can have a unique ID (similar to requirement IDs) represented in question inventory 50, and requirement IDs for individual requirements of standards 14 can be associated with corresponding question IDs for questions that are associated with the respective requirements. In one such example, question inventory 50 can be organized in lists or tables that include requirement IDs and corresponding question IDs (or vice versa). In other examples, question inventory 50 can be any suitable data structure capable of organizing data (i.e., corresponding questions) such that relationships between the data are maintained. As illustrated in FIG. 2, operational definition module 36 accesses question inventory 50 to obtain information from question inventory 50, such as one or more questions representing requirement operational definitions.

Library 28 also includes recommendation inventory 52. Recommendation inventory 52 stores information security and/or privacy compliance recommendations. Recommendations in recommendation inventory 52 are associated with individual questions from question inventory 50 (and client responses to those questions) and/or requirements of standards 14. In some examples, recommendations are matched 1:1 with questions or requirements, i.e., each recommendation can be associated with one corresponding question or requirement. In examples when a recommendation is associated with a requirement of standards 14 (rather than an individual question from question inventory 50), then the respective recommendation can be broader in scope. Recommendations can represent specific action items for a client organization that is being assessed. Recommendations can also summarize or explain the goal or other considerations of the corresponding question or requirement. In some examples, all or a portion of recommendations can be sourced from supplementary publications from authoritative sources of standards 14.

Like question inventory 50, recommendation inventory 52 can, in some examples, include an exhaustive list of recommendations. As such, recommendation inventory 52 can also be described as including both a baseline set of recommendations as well as optional recommendations. The baseline recommendations can be generic recommendations that are applicable to all (or almost all) organizations that use GRC tool 12. For example, the baseline recommendations can represent “good practice” or common strategies for implementing requirements of standards 14. Some non-limiting examples of baseline recommendations are to perform at least monthly vulnerability scans, to review and monitor or update policies at least annually, to review security awareness topics, to review security logs daily for sensitive environments, that inventory should be current within a week to a month, that every asset in an inventory should have an asset owner, etc. On the other hand, optional recommendations can be formulated to cover any number of specific client circumstances that may not be generally applicable to all organizations that use GRC tool 12.

Recommendations in recommendation inventory 52 can also be associated with indications (e.g., with a metadata tag) of corresponding information for the respective recommendation, such as applicable domains, reference materials, sources, etc. Recommendations can also be associated with a priority indicator. In one example, the priority indicator can indicate whether the recommendation is high, moderate, or low priority. In other examples, other categories or designations of priority can be used. The priority indicator assigned to a recommendation in recommendation inventory 52 can be a baseline priority suggestion that is modifiable (e.g., by an instruction from assessor 18, as described below with reference to FIG. 9). For example, a recommendation to perform a weekly scan and update asset inventories can be assigned a high priority indicator in recommendation inventory 52 because this might be a task that is always recommended and is considered important for a client organization to maintain a current inventory that reflects its current environment. In some examples, one or more recommendations in recommendation inventory 52 do not have any priority indicator associated therewith.

One or more recommendations can be linked in recommendation inventory 52 to corresponding questions from question inventory 50 and/or requirements of standards 14. For example, each recommendation can have a unique ID (similar to question and requirement IDs) represented in recommendation inventory 52, and question IDs for individual questions from question inventory 50 or requirement IDs for requirements of standards 14 can be associated with corresponding recommendation IDs for recommendations that are associated with the respective question or requirement. In one such example, recommendation inventory 52 can be organized in lists or tables that include recommendation IDs and corresponding question and/or requirement IDs (or vice versa). In other examples, recommendation inventory 52 can be any suitable data structure capable of organizing data (i.e., recommendations) such that relationships between the data are maintained. As illustrated in FIG. 2, recommendations module 40 accesses recommendation inventory 52 to obtain information from recommendation inventory 52.

Library 28 includes multi-dimensional mapping of requirements from standards inventory 44 in requirement dependencies map 46, domains map 48, and question inventory 50. In some examples, requirements are linked in library 28 across standards inventory 44, requirement dependencies map 46, domains map 48, and question inventory 50, such that all the mapping information for each requirement is available concurrently in GRC tool 12. Equivalent multi-dimensional mapping of requirements of standards 14 would be difficult or impossible to maintain and dynamically access by hand.

Library 28 has accumulated within GRC tool 12 all the basic information needed for generating and administering effective information security and/or privacy assessments. That is, relevant information from one or more of standards inventory 44, requirement dependencies map 46, domains map 48, question inventory 50, and recommendation inventory 52 can be automatically accessed from library 28 when needed by GRC tool 12 (or by client 16 and/or assessor 18). This drastically reduces the need for client 16 and/or assessor 18 to attempt to manually research and collect similar information, which allows GRC tool 12 to be more efficient.

According to some assessments, there are an average of 200 updates globally on a daily basis to standards 14. Someone who maintains GRC tool 12 (e.g., a developer) can add or update corresponding information in library 28, such as with downloadable software updates that are made available to clients or by directly updating the code, for example. Initially, standards inventory 44 could be updated to include the most up-to-date information about standards 14, including new or changed requirements. In one example, an update that includes a relatively minor change to the wording of an existing requirement could be automatically populated throughout library 28 (i.e., the affected requirement language could be automatically updated in any or all places where it appears in library 28), based on the linking of the requirement in the various maps in library 28 (standards inventory 44, requirement dependencies map 46, domains map 48, and question inventory 50). In other examples, such as for updates that add new requirements or more significantly alter existing requirements, standards inventory 44, requirement dependencies map 46, domains map 48, and question inventory 50 could be revised or re-mapped to accommodate the new or different requirements.

Once library 28 (including standards inventory 44, requirement dependencies map 46, domains map 48, question inventory 50) includes the updated information, the updated information can automatically be applied to a client instruction (as will be described in greater detail below with reference to FIG. 3). In some examples, an ongoing audit or assessment using GRC tool 12 could be automatically adjusted to include the updated information. In some such examples, this could include generating a notification via workflow management module 42 that indicates the updated information. The notification of the updated information could include an indication of how the updated information affects a previous version of an audit or assessment (i.e., what changes were made). Accordingly, client 16 using GRC tool 12 would not be required to perform continued research of standards 14 to determine how updates to standards 14 will affect audits or assessments.

The functionality of various modules of GRC tool 12 will be described in the following sections with reference to FIGS. 3-9. Standards module 30, dependency mapping module 32, domain mapping module 34, operational definition module 36, client response module 38, and recommendations module 40 will generally be described sequentially; however, it should be understood that these modules need not always be performed in any particular order and may also include overlapping or interspersed functionality. Moreover, some of the modules may also include functionality that occurs concurrently with the functionality of other modules. For example, at least a portion of the functionality of dependency mapping module 32, domain mapping module 34, and/or operational definition module 36 can be concurrent, i.e., dependency mapping, domain mapping, and/or operational definition identification can occur concurrently. In some examples, concurrently means occurring without an intervening instruction or action. In some examples, concurrently means simultaneously or in parallel.

FIG. 3 is a schematic block diagram illustrating details of standards module 30 of GRC tool 12. FIG. 3 shows standards module 30, standards inventory 44 (including applicable standards 54), client instruction 56, and requirements set 58.

As illustrated in FIG. 3, standards module 30 receives client instruction 56 as an input. Client instruction 56 is data that is passed into GRC tool 12 that represents an instruction for standards module 30. Client instruction 56 can be an instruction from client 16 that is entered via user interface 26 (shown in FIG. 1). Specifically, client instruction 56 can include an indication of one or more of standards 14 and corresponding requirements. For example, client instruction 56 can indicate which information security and/or privacy standards a client organization is subject to. In some examples, client instruction 56 can indicate that the entirety of one or more standards 14 is applicable. In other examples, client instruction 56 can indicate individual requirements that should be included or excluded. For example, client instruction 56 can include a list of IDs associated with one or more individual requirements to include or exclude. Client instruction 56 can also include other information about the client organization, such as applicable industries, etc., which can be stored in memory 24 of GRC tool 12. Information about the client organization can be used in GRC tool 12 by assessor 18 (shown in FIG. 1) to identify the scope for an audit of the client organization. Moreover, this additional information about the client organization can be used as a comparison point in case the client organization changes in some way (e.g., the client organization goes through an acquisition and takes on a new kind of sensitive data) that changes which of standards 14 are applicable. Workflow management module 42 (shown in FIG. 1) can generate an alert or notification associated with a change in the client organization information when new client instructions 56 are received. For example, an alert could recommend that a reassessment is needed.

Standards module 30 includes methods in code for determining which of standards 14 and which corresponding requirements (e.g., which IDs) are indicated in client instruction 56 and accessing the corresponding ones of standards 14 from standards inventory 44. That is, standards module 30 accesses applicable standards 54 from standards inventory 44 based on client instruction 56. Applicable standards 54 are the one or more standards 14 that are indicated by client instruction 56. Standards module 30 further selects a set of requirements associated with applicable standards 54 according to client instruction 56. Depending on client instruction 56, standards module 30 can select all or a portion of the individual requirements associated with applicable standards 54. Standards module 30 can output the set of requirements as requirements set 58 to other modules of GRC tool 12. In examples where standards inventory 44 includes standards 14 in a crosswalk format, requirements set 58 generally will not include overlapping requirements between different ones of standards 14.

FIG. 4 is a schematic block diagram illustrating details of dependency mapping module 32 of GRC tool 12. FIG. 4 shows dependency mapping module 32, requirement dependencies map 46, requirements set 60, assessor instruction 62, and dependency-mapped requirements set 64.

As illustrated in FIG. 4, dependency mapping module 32 receives requirements set 60 as an input. Dependency mapping module 32 can receive requirements set 60 from standards module 30 or domain mapping module 34 (shown in FIG. 1). That is, requirements set 60 can be an example of requirements set 58 (shown in FIG. 3) or domain-mapped requirements set 70 (as described below with reference to FIG. 5).

Dependency mapping module 32 also accesses requirement dependencies map 46. Requirement dependencies map 46 is described above with reference to FIG. 2 and stores dependencies between requirements of standards 14. Dependency mapping module 32 includes methods in code for mapping dependencies of requirements set 60. Based on the individual requirements present in requirements set 60, dependency mapping module 32 can access requirement dependencies map 46 to determine which, if any, dependencies correspond to individual requirements of requirements set 60. For example, dependency mapping module 32 can determine which requirement IDs are present in requirements set 60 and search for the same (or corresponding) requirement IDs in requirement dependencies map 46 to determine if the requirement IDs are associated with any dependent requirements.

When dependent requirements are identified from requirement dependencies map 46 for one or more requirements of requirements set 60, dependency mapping module 32 can then automatically associate the one or more requirements of requirements set 60 with the appropriate corresponding dependencies to form dependency-mapped requirements set 64. In some examples, this association can take the form of an indication, such as a metadata tag or the like, that dependency mapping module 32 associates with the one or more requirements of requirements set 60 to indicate, or link to, corresponding dependent requirements. For example, dependency mapping module 32 could link a requirement ID represented in requirements set 60 with a set of requirement IDs of corresponding dependent requirements for that requirement. The corresponding dependencies of requirements in dependency-mapped requirements set 64 indicate that a first, dependent requirement from requirements set 60 is a function of a second requirement from requirements set 60 and that information that is relevant to the first, dependent requirement is also relevant to the second requirement.

As illustrated in FIG. 4, dependency mapping module 32 also receives assessor instruction 62 as an input. Like client instruction 56 (shown in FIG. 3), assessor instruction 62 is data that is passed into GRC tool 12 that represents an instruction for dependency mapping module 32. Assessor instruction 62 can be an instruction from assessor 18 that is entered via user interface 26 (shown in FIG. 1). More specifically, assessor instruction 62 is an instruction to modify requirement dependencies map 46 and/or how dependencies represented in requirement dependencies map 46 are applied to requirements set 60 (e.g., by modifying an associated indication of corresponding dependent requirements), thereby also modifying dependency-mapped requirements set 64. Assessor instruction 62 enables assessor 18 (shown in FIG. 1) to remap (i.e., redefine or alter) requirement dependencies based on other information, which in turn makes dependency mapping module 32 more flexible. For example, assessor instruction 62 can represent a decision by assessor 18 based on a subjective evaluation of the client organization's particular circumstances or some other real-world context. In other examples, dependency mapping module 32 does not receive assessor instruction 62 and, accordingly, forms dependency-mapped requirements set 64 based on the corresponding dependencies as stored in requirement dependencies map 46 without further adjustment.

Dependency mapping module 32 outputs dependency-mapped requirements set 64. As described above, dependency-mapped requirements set 64 includes one or more requirements of standards 14 associated with corresponding dependent requirements. Moreover, if dependency-mapped requirements set 64 were generated using domain-mapped requirements set 70 (as described below with reference to FIG. 5), then dependency-mapped requirements set 64 will retain the domain mapping from domain-mapped requirements set 70. In some examples, dependency-mapped requirements set 64 can be output to other modules of GRC tool 12, including domain mapping module 34 and operational definition module 36 (shown in FIG. 1). In other examples, workflow management module 42 (shown in FIG. 1) can cause dependency-mapped requirements set 64 to be output to client 16 and/or assessor 18 via user interface 26 (shown in FIG. 1), such as in a report.

Dependency mapping module 32 allows GRC tool 12 to identify dependencies between requirements of information security and/or privacy standards 14 for more consistent assessments of information security and/or privacy compliance. Without dependency mapping, a client organization could provide conflicting information in response to various requirements that are dependent in some way on one another. Additionally, these dependencies would be unwieldy to track manually because an organization can be subject to any combination of hundreds or thousands of requirements and each assessment generated based on these requirements can have hundreds or thousands of questions such that it would be extremely difficult to notice instances where conflicting information is provided. GRC tool 12 including dependency mapping module 32 can enforce consistency in user responses associated with each of the dependency-mapped requirements. With dependencies mapped via dependency mapping module 32, assessor 18 can readily identify any discrepancies in client responses based on dependencies and investigate further.

FIG. 5 is a schematic block diagram illustrating details of domain mapping module 34 of GRC tool 12. FIG. 5 shows domain mapping module 34, domains map 48, requirements set 66, assessor instruction 68, and domain-mapped requirements set 70.

As illustrated in FIG. 5, domain mapping module 34 receives requirements set 66 as an input. Domain mapping module 34 can receive requirements set 66 from standards module 30 or dependency mapping module 32 (shown in FIG. 1). That is, requirements set 66 can be an example of requirements set 58 (shown in FIG. 3) or dependency-mapped requirements set 64 (shown in FIG. 4).

Domain mapping module 34 also accesses domains map 48. Domains map 48 is described above with reference to FIG. 2 and stores associations of requirements of standards 14 with domains. Domain mapping module 34 includes methods in code for mapping domains of requirements set 66. Based on the individual requirements present in requirements set 66, domain mapping module 34 can access domains map 48 to determine which domains correspond to which individual requirements of requirements set 66. For example, domain mapping module 34 can determine which requirement IDs are present in requirements set 66 and search for the same (or corresponding) requirement IDs in domains map 48 to determine which domains (e.g., which domain IDs) correspond to the requirement IDs.

Once corresponding domains are identified from domains map 48 for each requirement of requirements set 66, domain mapping module 34 can then automatically associate each requirement of requirements set 66 with the appropriate corresponding domain or domains to form domain-mapped requirements set 70. In some examples, this association can take the form of an indication, such as a metadata tag or the like, that domain mapping module 34 associates with individual requirements of requirements set 66 to indicate, or link to, corresponding domains. For example, domain mapping module 34 could link each requirement ID represented in requirements set 66 to one or more corresponding domain IDs. The corresponding domains of requirements in domain-mapped requirements set 70 indicate which domains from domains map 48 are relevant for the requirements of requirements set 66.

As illustrated in FIG. 5, domain mapping module 34 also receives assessor instruction 68 as an input. Like client instruction 56 (shown in FIG. 3) and assessor instruction 62 (shown in FIG. 4), assessor instruction 68 is data that is passed into GRC tool 12 that represents an instruction for domain mapping module 34. Assessor instruction 68 can be an instruction from assessor 18 that is entered via user interface 26 (shown in FIG. 1). More specifically, assessor instruction 68 is an instruction to modify domains map 48 and/or how domains represented in domains map 48 are applied to requirements set 66 (e.g., by modifying an associated indication of corresponding domains), thereby also modifying domain-mapped requirements set 70. Assessor instruction 68 enables assessor 18 (shown in FIG. 1) to remap (i.e., redefine or alter) corresponding domains based on other information, which in turn makes domain mapping module 34 more flexible. For example, assessor instruction 68 can represent a decision by assessor 18 based on a subjective evaluation of the client organization's particular circumstances or some other real-world context. In other examples, domain mapping module 34 does not receive assessor instruction 68 and, accordingly, forms domain-mapped requirements set 70 based on the corresponding domains as stored in domains map 48 without further adjustment.

Domain mapping module 34 outputs domain-mapped requirements set 70. As described above, domain-mapped requirements set 70 includes one or more requirements of standards 14 associated with one or more corresponding domains. Moreover, if domain-mapped requirements set 70 was generated using dependency-mapped requirements set 64 (shown in FIG. 4), then domain-mapped requirements set 70 will retain the dependency mapping from dependency-mapped requirements set 64. In some examples, domain-mapped requirements set 70 can be output to other modules of GRC tool 12, including dependency mapping module 32 and operational definition module 36 (shown in FIG. 1). In other examples, workflow management module 42 (shown in FIG. 1) can cause domain-mapped requirements set 70 to be output to client 16 and/or assessor 18 via user interface 26 (shown in FIG. 1), such as in a report.

Domain mapping module 34 allows GRC tool 12 to group requirements of information security and/or privacy standards 14 into domains to improve planning, compliance monitoring, and control implementation within a client organization. Within an organization, there are typically certain teams or functional areas that are responsible for implementing particular controls based on requirements of information security and/or privacy standards and that will have (or have access to) the necessary information for responding to respective parts of information security and/or privacy assessments. For instance, only the software development team within an organization may have the ability to monitor or implement certain software development-related requirements.

However, most information security and privacy standards are not organized into a consistent set of domains. Rather, information security and privacy standards are each structured differently with all the corresponding requirements organized in some other scheme. If the information security or privacy standard does have some version of a higher-level domain represented in its structure, there are still many variations, with some standards being represented as dozens of domains and others only a few. Without domain mapping, a client organization would receive the unorganized set of requirements with which it needs to comply and have to build a domain map from scratch to assign requirements to appropriate functional areas.

GRC tool 12 including domain mapping module 34 is able to automatically bundle requirements based on a consistent set of domains. In this way, a client organization can use GRC tool 12 to easily keep track of which requirements are assigned to which work team and more effectively plan for, respond to, and implement the requirements.

FIG. 6 is a schematic block diagram illustrating details of operational definition module 36 of GRC tool 12. FIG. 6 shows operational definition module 36, question inventory 50 (including applicable questions 72), requirements set 74, assessor instruction 75, and overall question set 76.

As illustrated in FIG. 6, operational definition module 36 receives requirements set 74 as an input. Operational definition module 36 can receive requirements set 74 from standards module 30, dependency mapping module 32, or domain mapping module 34 (shown in FIG. 1). That is, requirements set 74 can be an example of requirements set 58 (shown in FIG. 3), dependency-mapped requirements set 64 (shown in FIG. 4), or domain-mapped requirements set 70 (shown in FIG. 5). In other words, in some examples, requirements set 74 can include requirements for which dependencies and/or domains are mapped, and, in other examples, requirements set 74 may not include dependency and/or domain mapping.

Operational definition module 36 also accesses question inventory 50. Question inventory 50 is described above with reference to FIG. 2 and stores questions representing operational definitions of requirements of standards 14. Operational definition module 36 includes methods in code for automatically selecting applicable questions 72 from question inventory 50 based on each requirement of requirements set 74. Based on the individual requirements present in requirements set 74, operational definition module 36 can access question inventory 50 to determine which questions correspond to which individual requirements of requirements set 74. For example, operational definition module 36 can determine which requirement IDs are present in requirements set 74 and search for the same (or corresponding) requirement IDs in question inventory 50 to determine which questions (e.g., which question IDs) correspond to the requirement IDs.

Once applicable questions 72 are identified from question inventory 50 for each requirement of requirements set 74, operational definition module 36 can then automatically associate each requirement of requirements set 74 with the appropriate corresponding questions of applicable questions 72 to generate overall question set 76. In some examples, this association can take the form of a list or set of tables that includes all the corresponding questions and an indication for each, such as a metadata tag or the like, that indicates or links to the respective requirement of requirements set 74 to which each question corresponds. For example, operational definition module 36 could link each requirement ID represented in requirements set 74 to one or more corresponding question IDs from applicable questions 72. The corresponding questions in overall question set 76 indicate which questions from question inventory 50 are relevant for the requirements of requirements set 74. Accordingly, overall question set 76 is a curated question set based on the particular client instruction 56 (shown in FIG. 3) that initiated its generation.

As illustrated in FIG. 6, operational definition module 36 also receives assessor instruction 75 as an input. Like client instruction 56 (shown in FIG. 3), assessor instruction 62 (shown in FIG. 4), and assessor instruction 68 (shown in FIG. 5), assessor instruction 75 is data that is passed into GRC tool 12 that represents an instruction for operational definition module 36. Assessor instruction 75 can be an instruction from assessor 18 that is entered via user interface 26 (shown in FIG. 1). More specifically, assessor instruction 75 is an instruction to modify question inventory 50 and/or applicable questions 72 (e.g., by adding, removing, or altering questions), thereby also modifying overall question set 76. For example, assessor instruction 75 can be an instruction to add organization-specific questions and keep or alter any baseline questions. Assessor instruction 75 enables assessor 18 (shown in FIG. 1) to change questions of questions inventory 50, such as applicable questions 72, based on other information, which in turn makes operational definition module 36 more flexible. For example, assessor instruction 75 can represent a decision by assessor 18 based on a subjective evaluation of the client organization's particular circumstances or some other real-world context. In other examples, operational definition module 36 does not receive assessor instruction 75 and, accordingly, forms overall question set 76 based on applicable questions 72 as stored in question inventory 50 without further adjustment.

Operational definition module 36 outputs overall question set 76. As described above, overall question set 76 includes a curated set of questions associated with one or more requirements of standards 14 that includes, or represents, corresponding operational definitions for the respective requirements. Moreover, if overall question set 76 was generated using dependency-mapped requirements set 64 (shown in FIG. 4) and/or domain-mapped requirements set 70 (shown in FIG. 5), then overall question set 76 will retain the dependency and/or domain mapping from dependency-mapped requirements set 64 and domain-mapped requirements set 70. Operational definition module 36 can output overall question set 76 to client response module 38 or to recommendations module 40.

Operational definition module 36 allows GRC tool 12 to break down requirements of information security and/or privacy standards 14 into questions that represent operational definitions of the requirements for more objective and consistent assessments of information security and/or privacy compliance. Typically, compliance assessments attempt to score organizations on broad requirements of information security and privacy standards, which are not well defined. The operational definitions represented in question inventory 50 make these broad requirements more objective and, accordingly, more quantifiable or measurable, which is a more ideal level for capturing client responses in an assessment. Thus, to determine if a broad requirement is satisfied, a client organization can be asked all the questions representing the operational definition of the requirement. In this way, operational definition module 36 facilitates more effectively scoring a client organization's information security and/or privacy posture.

If requirements are not broken down into consistent operational definitions, individual assessors could have their own interpretation of what a broad requirement means and then return inconsistent recommendations to a client organization. In contrast, GRC tool 12 including operational definition module 36 can help produce a consistent action plan for the client organization to implement. Additionally, the burden on assessor 18 is significantly reduced because question inventory 50 provides a consistent baseline set of questions that can be used as a substantial starting point for tailoring a compliance assessment for a particular organization.

FIG. 7A is a schematic block diagram illustrating details of client response module 38 of GRC tool 12. FIG. 7A shows client response module 38, overall question set 76, client responses 78, and linked questions and client responses 80.

As illustrated in FIG. 7A, client response module 38 receives overall question set 76 as an input from operational definition module 36. Client response module 38 includes methods in code for providing overall question set 76 to one or more users (e.g., via user interface 26 to client 16, as shown in FIG. 1). The format of overall question set 76 as it is provided to the one or more users by client response module 38 can be configurable, such as by assessor 18 (shown in FIG. 1) or a developer, for example. Client response module 38 can provide overall question set 76, along with any indications (e.g., of corresponding dependencies, corresponding domains, etc.) associated with the individual questions or underlying requirements that make up overall question set 76. In some examples, overall question set 76 can be provided to the one or more users as part of an audit or assessment of a client organization.

Client response module 38 also includes methods in code for receiving client responses 78 as another input after overall question set 76 has been provided to one or more users. Client responses 78 are responses from the one or more users (e.g., client 16, as shown in FIG. 1) to questions of overall question set 76. Client response module 38 can receive client responses 78 via user interface 26 (shown in FIG. 1). For example, the one or more users can access and review questions of overall question set 76 and provide client responses 78 in response. Client responses 78 can include simple answers, such as “yes,” “no,” “partially,” “unknown,” “not applicable,” or other variations of these, or can be in a freeform or narrative format, or can be a combination of simple and narrative answers, depending on the format of overall question set 76 provided by client response module 38. In some examples, client response module 38 can provide overall question set 76 to the one or more users in a format that includes multiple options, such as in a drop-down menu or the like, for simple answers as well as a narrative comment field for more in depth or customized answers to each question. Client response module 38 can also provide an interface for the one or more users to upload evidence (e.g., an image file, a text file, etc.) as part of client responses 78.

In examples where overall question set 76 includes dependency mapping (i.e., if overall question set 76 was generated from dependency-mapped requirements set 64, as shown in FIG. 4), client response module 38 can be configured to automatically flag or indicate any discrepancies in client responses 78 based on the corresponding dependencies, such as if client responses 78 for dependent requirements are inconsistent. In some examples, workflow management module 42 can also generate an alert or notification indicating any discrepancies. In this way, client response module 38 can automatically enforce, or implement, dependencies between dependent requirements that were mapped by dependency mapping module 32 (shown in FIG. 4).

As shown in FIG. 7A, client response module 38 outputs linked questions and client responses 80. Client response module 38 links or associates questions of overall question set 76 with corresponding client responses 78 to form linked questions and client responses 80. In some examples, linked questions and client responses can be output to recommendations module 40, as will be described below with reference to FIG. 9. In other examples, workflow management module 42 (shown in FIG. 1) can cause linked questions and client responses 80 to be output to client 16 and/or assessor 18 via user interface 26 (shown in FIG. 1), such as in a report.

Linked questions and client responses 80 can serve as the basis for assessing a client organization's compliance with standards 14 (i.e., applicable standards 54 according to client instruction 56, as shown in FIG. 3). Generally, a client organization is assessed based on a level of compliance with the requirements of one or more information security and/or privacy standards; however, linked questions and client responses 80 can also be scored to assess compliance, as will be described in greater detail below with reference to FIG. 9. Compared to assessing compliance only at the higher-level requirements, an assessment based on linked questions and client responses 80 can be more accurate and effective overall because linked questions and client responses 80 are a more granular representation of the client organization's compliance activities.

FIG. 7B is a schematic block diagram illustrating overall question set 76′ including domain-mapped subset question sets 82 as inputs to client response module 38 of GRC tool 12. FIG. 7B shows client response module 38, overall question set 76′, client responses 78′, and linked questions and client responses 80. As shown in FIG. 7B, overall question set 76′ includes domain-mapped subset question sets 82 (including individual domain subset question sets 82A-82n, where “n” is used herein as an arbitrary integer to indicate any number of the referenced component), and client responses 78′ includes domain client responses 84A-84n.

Client response module 38 is generally described above with reference to FIG. 7A. In the example illustrated in FIG. 7B, client response module 38 receives overall question set 76′ as an input from operational definition module 36. Overall question set 76′ can be an example of overall question set 76 (shown in FIGS. 6-7A) that was generated from domain-mapped requirements set 70 (shown in FIG. 5). In such examples, questions of overall question set 76′ retain the domain mapping from domain-mapped requirements set 70 and so can be organized, or categorized, within overall question set 76′ based on the corresponding domains. Alternatively, overall question set 76′ can be an example of overall question set 76 (shown in FIGS. 6-7A) that includes questions that are individually associated with one or more domains based on mapping or linking, such as with metadata tags associated with the respective questions, that is present in question inventory 50 (shown in FIG. 6). This example is conceptually similar to the domain mapping carried out by domain mapping module 34 (shown in FIG. 5) but with domains linked to individual questions rather than to the higher-level requirements (e.g., of domain-mapped requirements set 70, as shown in FIG. 5). The difference between these variations giving rise to overall question set 76′ is that all questions for a given requirement would be associated with the same domains when overall question set 76′ is generated based strictly on domain-mapped requirements set 70, but when overall question set 76′ includes at least some individually domain-mapped questions, some questions that are associated with the same requirement could be associated with different domains.

More specifically, overall question set 76′ includes domain-mapped subset question sets 82, including individual domain subset question sets 82A-82n, each of which can be associated with a corresponding domain. Although illustrated in FIG. 7B as five domain subset question sets 82A, 82B, 82C, 82D, and 82n, it should be understood that other examples can include any number of domain subset question sets 82A-82n. For example, the number of domain subset question sets 82A-82n can match the number of domains represented in domain-mapped requirements set 70 (shown in FIG. 5). Domain subset question set 82A can include questions associated with a first domain, domain subset question set 82B can include questions associated with a second domain, domain subset question set 82C can include questions associated with a third domain, domain subset question set 82D can include questions associated with a fourth domain, and domain subset question set 82n can include questions associated with a fifth domain. In some examples, multiple of domain subset question sets 82A-82n can include at least some overlapping (i.e., replicate) questions, indicating that some requirements of standards 14 impact more than one domain. In other examples, each of domain subset question sets 82A-82n includes different questions.

Client response module 38 can provide overall question set 76′ and/or individual domain subset question sets 82A-82n to one or more users. In some examples, each of domain subset question sets 82A-82n can be accessed independently, e.g., via user interface 26 by client 16 (shown in FIG. 1). In some examples, only users who are associated with the corresponding domain, such as by being part of a corresponding team within an organization, can access a respective one of domain subset question sets 82A-82n. For example, if domain subset question set 82A is a question set associated with a contingency planning domain, then only users who are also associated with the contingency planning domain (e.g., who are part of a contingency planning team within the organization) may have access, such with appropriate login credentials, to domain subset question set 82A from GRC tool 12. In some examples, workflow management module 42 can create a corresponding dashboard for each of domain subset question sets 82A-82n that can be displayed to corresponding users via user interface 26.

Ones of domain subset question sets 82A-82n, or affected questions of domain subset question sets 82A-82n, can also include an indication if there is overlap with another one of domain subset question sets 82A-82n. In some examples, workflow management module 42 (shown in FIG. 1) can generate an alert or notification of the overlapping questions between ones of domain subset question sets 82A-82n. Overlapping questions (and the underlying requirements of standards 14) can ultimately be assigned to a single domain, either by an updated indication or manually in a business workflow process. However, there may be very little interaction between domains within an organization, so, in some examples, overlapping questions can initially appear in all domain subset question sets 82A-82n that include the overlapping questions. In this way, users associated with the relevant domains can all be readily made aware of the overlapping questions or requirements, which likely represent overlapping tasks for implementation. From the workflow management perspective within the client organization, one domain (e.g., one work team) can take ownership of the overlapping question or requirement so that the same question or requirement is not addressed multiple times.

Client responses 78′ are an example of client responses 78 (shown in FIG. 7A) that are received from one or more users associated with one or more domains. More specifically, client responses 78′ include individual domain client responses 84A-84n, each of which can be associated with a corresponding domain. In some examples, each of domain client responses 84A-84n can represent responses from a separate work team associated with a particular domain for a client organization. For example, domain client responses 84A can be responses from a first work team associated with a first domain, domain client responses 84B can be responses from a second work team associated with a second domain, domain client responses 84C can be responses from a third work team associated with a third domain, domain client responses 84D can be responses from a fourth work team associated with a fourth domain, and domain client responses 84n can be responses from a fifth work team associated with a fifth domain.

Although illustrated in FIG. 7B as five sets of domain client responses 84A, 84B, 84C, 84D, and 84n, it should be understood that other examples can include any number of domain client responses 84A-84n. In some examples, the number of domain client responses 84A-84n can match the number of domain subset question sets 82A-82n because each of domain client responses 84A-84n can represent responses to a corresponding one of domain subset question sets 82A-82n. For example, domain client responses 84A can be responses to questions of domain subset question set 82A, domain client responses 84B can be responses to questions of domain subset question set 82B, domain client responses 84C can be responses to questions of domain subset question set 82C, domain client responses 84D can be responses to questions of domain subset question set 82D, and domain client responses 84n can be responses to questions of domain subset question set 82n. In other examples, ones of domain client responses 84A-84n may encompass more than one of domain client responses 82A-82n. One such example might occur when the client organization desires questions to be divided into more domain subset question sets 82A-82n for clarity based on subject-matter but then prefers relatively less strict domain definitions on the response side.

Like as described above with reference to FIG. 7A, client response module 38 links questions of overall question set 76′ to corresponding responses of client responses 78′ to form linked questions and client responses 80, which is the output of client response module 38. In the example shown in FIG. 7B, client response module 38 specifically links questions of individual domain subset question sets 82A-82n to corresponding domain client responses 84A-84n. As described previously, linked questions and client responses 80 can serve as the basis for scoring a client organization's compliance with respect to standards 14.

FIG. 8 is schematic block diagram illustrating concurrent updates for linked questions 89 of overall question set 76. FIG. 8 shows client response module 38, overall question set 76, client response 86, and linked questions and client responses 80. As shown in FIG. 8, overall question set 76 includes questions 88A-88n, linked questions 89, and question response fields 90A-90n.

Overall question set 76 is generally described above with reference to FIG. 7A. As shown in FIG. 8, overall question set 76 includes individual questions 88A-88n. Although five individual questions 88A, 88B, 88C, 88D, and 88n are shown, it should be understood that other examples can include any number of questions 88A-88n. In some examples, overall question set 76 can include hundreds or thousands of questions 88A-88n.

Each of questions 88A-88n has a corresponding question response field 90A-90n for populating a relevant client response. For example, question 88A corresponds to question response field 90A, question 88B corresponds to question response field 90B, question 88C corresponds to question response field 90C, question 88D corresponds to question response field 90D, and question 88n corresponds to question response field 90n. Question response fields 90A-90n can populate simple responses, narrative responses, or a combination of simple and narrative responses as described previously, depending on the configuration of client response module 38.

As shown in FIG. 8, question set 76 can further include linked questions 89. Linked questions 89 are ones of questions 88A-88n that are linked or associated with one another. The association between linked questions 89 is conceptually similar to the requirement dependencies stored in requirement dependencies map 48 (shown in FIG. 4) but with dependencies or associations between individual questions rather than between the higher-level requirements (e.g., of dependency-mapped requirements set 64, as shown in FIG. 4). Linked questions 89 can be linked in overall question set 76 based on mapping or linking, such as with metadata tags associated with each of linked questions 89, that is present in question inventory 50 (shown in FIG. 6). In the example shown in FIG. 8, question 88A and question 88C are linked questions 89. In other examples, any number of questions 88A-88n can be linked questions 89, and linked questions 89 are not limited to pairs of questions (i.e., there can be different groups of linked questions 89). In some examples, each of linked questions 89 can include an indication of, such as a metadata tag, or otherwise be associated with a list of the other corresponding linked questions 89. That is, in the example shown in FIG. 8, question 88A could include an indication of question 88C, and question 88C could include an indication of question 88A.

In some examples, linked questions 89 represent that one or more questions from question inventory 50 (shown in FIG. 6) are associated with multiple requirements (e.g., of requirements set 58 (shown in FIG. 3), dependency-mapped requirement set 64 (shown in FIG. 4), or domain-mapped requirements set 70 (shown in FIG. 5)), such that the same question appears in overall question set 76 multiple times—for example, once for each requirement with which the question is associated. That is, in some examples, linked questions 89 represent iterations of the same question, which may be identical. In other examples, linked questions 89 can represent that individual ones of questions 88A-88n are similar or address related subject matter (e.g., linked questions are both questions about software development, etc.). In yet other examples, linked questions 89 can represent that individual ones of questions 88A-88n are opposite questions (e.g., if the answer to a first one of linked questions 89 is “true,” then the answer to the other of linked questions 89 is “false,” etc.). In still other examples, linked questions 89 can represent other associations between individual ones of questions 88A-88n.

As shown in FIG. 8, client response module 38 receives client response 86, which can be an individual response of client responses 78 (shown in FIG. 7A). Client response 86 is a specific response to question 88A. When client response 86 is received by client response module 38, client response 86, or data representing client response 86, is populated into the corresponding question response field 90A. Question 88A is the first iteration of the pair of linked questions 89 in this example, so question response field 90A can be empty, or unpopulated, until client response 86 is received. Client response module 38 automatically populates question response field 90A based on client response 86 once client response 86 is received. Upon receiving client response 86, client response module 38 also concurrently updates question response field 90C associated with question 88C, which is the remaining iteration of linked questions 89 in overall question set 76. In some examples, concurrently means occurring without an intervening instruction or action. In some examples, concurrently means simultaneously. In some examples, question response field 90A and question response field 90C (i.e., corresponding response fields for linked questions 89) are linked in computer readable memory (e.g., memory 24, as shown in FIG. 1). In some such examples, question response field 90A and question response field 90C can share a same memory location (or address), such as by a pointer to the same memory location. In other such examples, question response field 90A and question response field 90C can have separate memory locations that are linked such that an update to one causes a concurrent update to the other. In examples that include additional linked questions 89 (i.e., more than two), the response field for each remaining linked question 89 will be updated concurrently by client response module 38 upon receiving a response associated with one of linked questions 89. Additionally, although concurrent updates have been described in a relatively forward direction with respect to progress through overall question set 76, the concurrent updates can also be carried out in a reverse direction such that a response to a later one of linked questions 89 can cause a concurrent update for previous ones of linked questions 89 in a similar manner, which can account for situations where a respondent reconsiders a previous response once provided a linked question in a different context.

The concurrent updates by client response module 38 for remaining ones of linked questions 89 (question 88C in the example shown in FIG. 8) can take several forms. In one example, the update can be an indication or tag associated with the corresponding response fields of the remaining linked questions 89. In other examples, the update can include auto-populating a response for the remaining linked questions 89. In yet other examples, the update can include overwriting a previously entered response for the remaining linked questions 89. More generally, the update can take any of these forms or any combination of these forms.

To illustrate, when question 88A and question 88C are the same or similar questions, such as questions that address similar subject matter, client response module 38 can concurrently update question response field 90C to include an indication or tag that indicates the same or similar question 88A (e.g., with a question ID corresponding to question 88A). Additionally or alternatively, when question 88A and question 88C are the same or similar questions, client response module 38 can auto-populate client response 86 into question response field 90C (and overwrite it if question response field 90C already contained a response). In a slightly different example, when question 88A and question 88C are the same or similar questions but client response 86 indicates question 88A is “not applicable,” an indication of “not applicable” based on client response 86 to question 88A can automatically be associated with question 88C (or question response field 90C can be auto-populated with a text response of “not applicable”). For example, question 88A and question 88C might both relate to software development, but certain organizations may not develop software or have any connection to software development, so both question 88A and question 88C would be inapplicable for that organization. In some examples, remaining linked questions 89 that are concurrently updated to be “not applicable” are not removed from overall question set 76. In another example, when question 88A and question 88C are opposite questions, question response field 90C can be auto-populated with an opposite response compared to client response 86, such as “yes” when client response 86 is “no” and vice versa. In yet another example, when question 88A and question 88C are associated in some other way, an indication of the other association between the questions can automatically be associated with question 88C.

The concurrent updates can be configurable and/or editable (e.g., by client 16 and/or assessor 18 via user interface 26, as shown in FIG. 1). In some examples, client response module 38 can be configured such that the concurrent updates are editable at the time responses are being entered or provided by client 16. In other examples, the concurrent updates can be editable by assessor 18 after client responses are received. In some examples, client response module 38 can also be configured such that client 16 and/or assessor 18 can adjust whether concurrent updates are applied globally within overall question set 76 (i.e., to all corresponding linked questions 89) or only to certain ones of linked questions 89. The concurrent updates applied by client response module 38 between linked questions 89 are preserved when client response module 38 forms linked questions and client responses 80.

The concurrent updates for linked questions 89 further improve the consistency and efficiency of information security and/or privacy assessments generated and administered using GRC tool 12. Additionally, the concurrent updates reduce the burden on respondents by reducing the number of times the same or similar questions are repeated and only requiring a response once.

FIG. 9 is schematic block diagram illustrating details of recommendations module 40 of GRC tool 12. FIG. 9 shows recommendations module 40, recommendation inventory 52 (including applicable recommendations 92), linked questions and client responses 80, assessor instruction 94, and final recommendations 96.

As illustrated in FIG. 9, recommendations module 40 receives linked questions and client responses 80 as an input from client response module 38 (shown in FIGS. 7A-8). In this way, recommendations module 40 receives all the information about the questions that were presented to client 16, the relationships between the questions and the underlying requirements of standards 14 (e.g., any corresponding dependencies and domains), and the responses that were received from client 16.

Recommendations module 40 can also access recommendation inventory 52. Recommendation inventory 52 is described above with reference to FIG. 2 and stores recommendations. Recommendations module 40 includes methods in code for automatically selecting applicable recommendations 92 from recommendation inventory 52 based on each question (and/or underlying requirement) of linked questions and client responses 80. Based on the individual questions present in linked questions and client responses 80, recommendations module 40 can access recommendation inventory 52 to determine which recommendations correspond to which individual questions (and/or underlying requirements) of linked questions and client responses 80. For example, recommendations module 40 can determine which question and/or requirement IDs are present in linked questions and client responses 80 and search for the same (or corresponding) question or requirement IDs in recommendation inventory 52 to determine which recommendations (e.g., which recommendation IDs) correspond to the question and/or requirement IDs. Alternatively, recommendations module 40 could be configured to automatically select applicable recommendations 92 from recommendation inventory 52 based on each question (and/or underlying requirement) of overall question set 76 (shown in FIG. 6) without first receiving client responses 78 (i.e., recommendations module 40 could receive overall question set 76 as an input from operational definition module 36 instead of receiving linked questions and client responses 80 from client response module 38).

Once applicable recommendations 92 are identified from recommendation inventory 52 for each question of linked questions and client responses 80, based on either the individual question itself and/or the underlying requirement of standards 14, recommendations module 40 can then automatically associate each question of linked questions and client responses 80 with the appropriate corresponding recommendations of applicable recommendations 92 to generate final recommendations 96. In some examples, this association can take the form of a list or set of tables that includes all the questions and corresponding recommendations. Alternatively, recommendations module 40 could link each question ID represented in linked questions and client responses 80 to corresponding recommendation IDs represented in applicable recommendations 92, such as with a metadata tag or the like that serves as an indication or link between questions and corresponding recommendations. The corresponding recommendations in final recommendations 96 indicate which recommendations from recommendation inventory 52 are relevant for linked questions and client responses 80.

As illustrated in FIG. 9, recommendations module 40 also receives assessor instruction 94 as an input. Like client instruction 56 (shown in FIG. 3), assessor instruction 62 (shown in FIG. 4), assessor instruction 68 (shown in FIG. 5), and assessor instruction 75 (shown in FIG. 6), assessor instruction 94 is data that is passed into GRC tool 12 that represents an instruction for recommendations module 40. Assessor instruction 94 can be an instruction from assessor 18 that is entered via user interface 26 (shown in FIG. 1). Assessor instruction 94 can include multiple parts. A first part of assessor instruction 94 can be an instruction for scoring compliance based on linked questions and client responses 80, and a second part of assessor instruction 94 can be an instruction modify the recommendations.

For example, assessor instruction 94 can include an instruction for scoring linked questions and client responses 80. Accordingly, recommendations module 40 can also include methods in code for incorporating a score with linked questions and client responses 80. Scoring linked questions and client responses 80 can be an additional step in the process of providing final recommendations 96 to client 16 (shown in FIG. 1). Assessor 18 can review linked questions and client responses 80 to determine if the client organization is compliant, partially compliant, or non-compliant with each question based on the corresponding response. Scoring linked questions and client responses 80 via assessor instruction 94 can take several forms. In one example, scoring can be binary, such as zero (0) or one (1), true or false, or other similar designations, to indicate compliant or non-compliant, respectively. In some examples, there can be more granular scoring to capture degrees of partial or uncertain compliance. Assessor instruction 94 can be an instruction to recommendations module 40 to assign a score to each question and response pair in linked questions and client responses 80.

The individual scores for question and response pairs can be added or otherwise combined into an overall score for underlying requirements of standards 14 represented by the questions. In some examples, scoring can be affected by weighting of individual questions of linked questions and client responses 80 (e.g., as described previously with reference to FIG. 2). For example, recommendations module 40 can be configured with thresholds relating to how many or what type of questions can be scored as non-compliant before an underlying requirement of standards 14 that is represented in linked questions and client responses 80 is considered non-compliant overall. Many iterations of this are possible, including considering the underlying requirement of standards 14 to be non-compliant if any corresponding higher weighted questions are individually scored non-compliant, or considering the underlying requirement of standards 14 to be non-compliant if a threshold number or percentage of corresponding higher weighted questions are individually scored non-compliant, such that the higher weighted questions have a greater impact on the overall score. For example, there could be circumstances where many lower weighted questions are compliant but one or a few higher weighted questions are non-compliant and the underlying requirement is still scored as compliant. In some examples, assessor 18 (shown in FIG. 1) can adjust the question weighting or thresholds for overall scoring up or down via assessor instruction 94. Recommendations module 40 can support any, all, or any combination of these scoring paradigms and can allow assessor 18 (shown in FIG. 1) to select among them via assessor instruction 94, making the scoring highly customizable.

Assessor instruction 94 can also include an instruction to modify recommendation inventory 52 and/or applicable questions 92 (e.g., by adding, removing, or altering recommendations), thereby also modifying final recommendations 96. Generally, there are several factors, including subjective evaluation by an assessor (e.g., assessor 18, as shown in FIG. 1), that can impact final recommendations 96. For example, assessor instruction 94 can be an instruction to add organization-specific recommendations and keep or alter any baseline recommendations. Assessor instruction 94 enables assessor 18 (shown in FIG. 1) to change recommendations of recommendation inventory 52, such as applicable recommendations 92, based on other information, which in turn makes recommendations module 40 more flexible. For example, assessor instruction 94 can represent a decision by assessor 18 based on a subjective evaluation of the client organization's particular circumstances or some other real-world context. In other examples, recommendations module 40 does not receive assessor instruction 94 and, accordingly, forms final recommendations 96 based on applicable recommendations 92 as stored in recommendation inventory 52 without further adjustment.

In some examples, assessor 18 can modify applicable recommendations 92 based on review of the client responses of linked questions and client responses 80. Because applicable recommendations 92 can represent action items for the client organization, assessor 18 can, in some examples, determine if any of the automatically selected applicable recommendations 92 are already implemented by the client organization and therefore can be removed or hidden from applicable recommendations 92. In some examples, assessor 18 can review narratives associated with the client responses and adjust the verbiage for applicable recommendations 92 to directly address aspects of the client responses. That is, assessor 18 has the ability using assessor instruction 94 to use the entirety of applicable recommendations 92 as was automatically provided, to use part of applicable recommendations 92, or to adjust applicable recommendations 92 based on the information provided by client 16 (shown in FIG. 1) in linked questions and client responses 80. In these and other examples, assessor instruction 94 can be guided by some predefined range for respective recommendations (e.g., the client organization could indicate that weekly scanning and updating asset inventories is not feasible, so assessor instruction 94 could adjust this recommendation up within some predefined acceptable range).

Assessor instruction 94 can also include an instruction to modify or add a priority indicator associated with one or more recommendations of recommendation inventory 52 (e.g., as described previously with reference to FIG. 2). For example, assessor instruction 94 can modify or add the priority indicator to indicate industry—or client-specific priorities. In some examples, assessor instruction 94 to modify or add the priority indicator can be based on an assessment of the client organization's current information security and/or privacy maturity compared to an target maturity. To illustrate, one general (or baseline) recommendation that might be automatically included in applicable recommendations 92 is for the client organization to perform an external penetration test (i.e., an external malicious actor tries to infiltrate). This recommendation may be sufficient for most organizations that have public-facing parts of their systems. On the other hand, an organization with more sensitive data may also benefit from performing an internal penetration test (i.e., an internal malicious actor tries to infiltrate), and assessor instruction 94 could change the baseline recommendation to include this additional recommendation. Alternatively, both external and internal penetration tests could be included in the initial recommendation from applicable recommendations 92 and assessor instruction 94 could remove one or the other.

Recommendations module 40 outputs final recommendations 96. Final recommendations 96 can be an overall output of GRC tool 12. For example, final recommendations 96 can represent a final assessment or audit of a client organization. Recommendations module 40 can output final recommendations 96 to client 16 via user interface 26 (shown in FIG. 1). Additionally, workflow management module 42 can generate reports (e.g., of an overall compliance score for the client organization), send alerts (e.g., for high priority recommendations), which can be directed to appropriate work teams (e.g., based on client organization domains).

Recommendations module 40 reduces the burden on assessor 18 by providing a substantial baseline of customizable recommendations for an assessment of a client organization, rather than requiring assessor 18 to deeply research guidelines for the requirements of information security and/or privacy standards 14 to develop recommendations from scratch. Additionally, GRC tool 12 including recommendation inventory 52 that is accessible by recommendations module 40 can automatically generate recommendations based on an initial instruction (e.g., client instruction 56, as shown in FIG. 3), so a client organization can also easily perform self-assessments without needing to do its own deep research into information security and/or privacy standards 14, which could be overwhelming for non-experts.

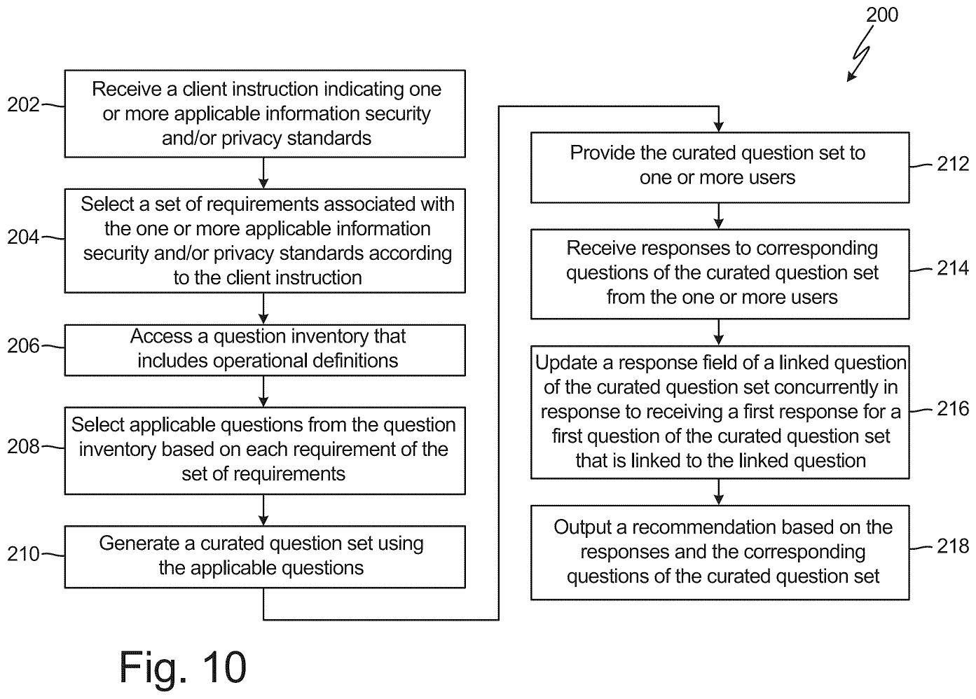

Several processes associated with GRC system 10 are shown in FIGS. 10-12. Accordingly, the processes illustrated in FIGS. 10-12 will be described with reference to components of GRC system 10 described above (FIGS. 1-9).

FIG. 10 is a process flowchart showing steps 202-218 of process 200 for generating and administering an information security and/or privacy assessment. As illustrated in FIG. 10, a first step of process 200 is receiving client instruction 56 indicating one or more applicable standards 54 of predefined information security and/or privacy standards 14 (step 202). Client instruction 56 can be received by standards module 30 of GRC tool 12. Each of standards 14 can include corresponding requirements. Standards module 30 can access standards 14 from standards inventory 44 in library 28. At step 204, standards module 30 selects a set of requirements (e.g., requirements set 58) associated with the one or more applicable standards 54 according to client instruction 56.

At step 206, operational definition module 36 of GRC tool 12 accesses question inventory 50 from library 28. Question inventory 50 includes operational definitions for the corresponding requirements of standards 14. At step 208, operational definition module 36 selects applicable questions 72 from question inventory 50 based on each requirement of the set of requirements (e.g., requirements set 74) associated with the one or more applicable standards 54, as indicated by client instruction 56. At step 210, operational definition module 36 generates curated overall question set 76 using applicable questions 72. Overall question set 76 includes a corresponding operational definition for each requirement of the set of requirements (e.g., requirements set 74). In some examples, overall question set 76 includes baseline questions and organization-specific questions. In some examples, assessor 18 can modify overall question set 76 via user interface 26 (e.g., by assessor instruction 75) before overall question set 76 is provided to one or more users.

At step 212, client response module 38 of GRC tool 12 provides overall question set 76 to one or more users. Client response module 38 can provide overall question set 76 via user interface 26. In some examples, overall question set 76 is provided to the one or more users as part of an audit or assessment of a client organization. In some such examples, individual questions of overall question set 76 can be weighted in the audit or the assessment. At step 214, client response module 38 receives client responses 78 to corresponding questions of overall question set 76 from the one or more users. In some examples, the one or more users can indicate that one or more questions in overall question set 76 are inapplicable.

At step 216, client response module 38 updates a response field (e.g., question response field 90C shown in FIG. 8) of a linked question (e.g., question 88C shown in FIG. 8) of overall question set 76 concurrently in response to receiving a first response (e.g., client response 86 shown in FIG. 8) for a first question (e.g., question 88A shown in FIG. 8) of overall question set 76 that is linked to the linked question. In some examples, the first question and the linked question represent a matching question, and the response field of the linked question is updated to include a same response as the first response. In other examples, the first question and the linked question represent opposite questions, and the response field of the linked question is updated to include an opposite response from the first response.

At step 218, recommendations module 40 of GRC tool 12 outputs a recommendation based on the responses and the corresponding questions of overall question set 76 (e.g., linked questions and client responses 80). In some examples, recommendations module 40 accesses recommendation inventory 52 stored in library 28, selects applicable recommendations 92 from recommendation inventory 52 based on the responses and the corresponding questions of overall question set 76, generates final recommendations 96 using applicable recommendations 92, and outputs final recommendations 96. In some examples, assessor 18 can modify applicable recommendations 92 via user interface 26 before final recommendations 96 are generated. In some examples, assessor 18 can score each of the responses and the corresponding questions of overall question set 76 as compliant, partially compliant, or not compliant. In some examples, final recommendations 96 represent action items for improving an information security and/or privacy posture of a client organization. In some examples, each of applicable recommendations 92 can include an indication of high, moderate, or low priority, the indication of high, moderate, or low priority being associated with an industry of a client organization or with a target information security and/or privacy maturity of the client organization. In some examples, each of the responses and the corresponding questions of overall question set 76 is associated with a corresponding one of applicable recommendations 92.

Step 218 can be a final step of process 200. Although illustrated as single steps, it should be understood that each of steps 202-218 can, in other examples, be repeated any number of times in process 200.

Process 200, including steps 206 and 208 for accessing question inventory 50 that includes operational definitions and selecting applicable questions 72, allows for more objective and consistent information security and/or privacy assessments.

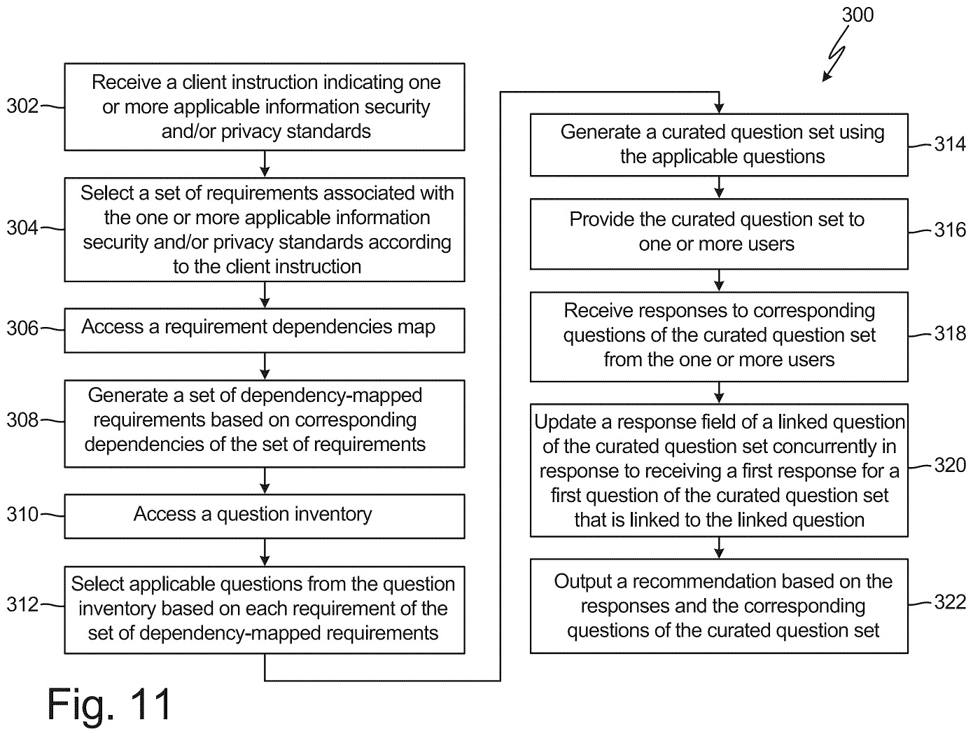

FIG. 11 is a process flowchart showing steps 302-322 of process 300 for generating and administering an information security and/or privacy assessment. As illustrated in FIG. 11, a first step of process 300 is receiving client instruction 56 indicating one or more applicable standards 54 of predefined information security and/or privacy standards 14 (step 302). Client instruction 56 can be received by standards module 30 of GRC tool 12. Each of standards 14 can include corresponding requirements. Standards module 30 can access standards 14 from standards inventory 44 in library 28. At step 304, standards module 30 selects a set of requirements (e.g., requirements set 58) associated with the one or more applicable standards 54 according to client instruction 56.

At step 306, dependency mapping module 32 of GRC tool 12 accesses requirement dependencies map 46 from library 28. Requirement dependencies map 46 represents dependencies between multiple requirements of the corresponding requirements of standards 14. At step 308, dependency mapping module 32 generates a set of dependency-mapped requirements (e.g., dependency-mapped requirements set 64) based on corresponding dependencies of the set of requirements (e.g., requirements set 60) associated with the one or more applicable standards 54 according to requirement dependencies map 46. In some examples, each dependent requirement of the set of dependency-mapped requirements (e.g., dependency-mapped requirements set 64) can include an indication of corresponding dependent requirements of the set of dependency-mapped requirements. In some examples, the corresponding dependencies of requirements set 60 indicate that a first requirement of requirements set 60 is a function of a second requirement of requirements set 60 and that information relevant to the first requirement is also relevant to the second requirement. In some examples, assessor 18 can modify the set of dependency-mapped requirements via user interface 26 (e.g., by assessor instruction 62) before the set of dependency-mapped requirements is provided to the one or more users.

At step 310, operational definition module 36 of GRC tool 12 accesses question inventory 50 from library 28. At step 312, operational definition module 36 selects applicable questions 72 from question inventory 50 based on each requirement of the set of dependency-mapped requirements (e.g., dependency-mapped requirements set 64). At step 314, operational definition module 36 generates curated overall question set 76 using applicable questions 72. In some examples, question inventory 50 includes operational definitions for the corresponding requirements of standards 14, and overall question set 76 includes a corresponding operational definition for each requirement of the set of dependency-mapped requirements (e.g., dependency-mapped requirements set 64). In some examples, each question of overall question set 76 includes an indication of corresponding dependent requirements of the set of dependency-mapped requirements.

At step 316, client response module 38 of GRC tool 12 provides overall question set 76 to one or more users. Client response module 38 can provide overall question set 76 via user interface 26. At step 318, client response module 38 receives client responses 78 to corresponding questions of overall question set 76 from the one or more users. In some examples, the one or more users can indicate that one or more questions in overall question set 76 are inapplicable. In some examples, the set of dependency-mapped requirements (e.g., dependency-mapped requirements set 64) enforces consistency in client responses 78 to the corresponding questions of overall question set 76 from the one or more users.

At step 320, client response module 38 updates a response field (e.g., question response field 90C shown in FIG. 8) of a linked question (e.g., question 88C shown in FIG. 8) of overall question set 76 concurrently in response to receiving a first response (e.g., client response 86 shown in FIG. 8) for a first question (e.g., question 88A shown in FIG. 8) of overall question set 76 that is linked to the linked question. In some examples, the first question and the linked question represent a matching question, and the response field of the linked question is updated to include a same response as the first response. In other examples, the first question and the linked question represent opposite questions, and the response field of the linked question is updated to include an opposite response from the first response.

At step 322, recommendations module 40 of GRC tool 12 outputs a recommendation based on the responses and the corresponding questions of overall question set 76 (e.g., linked questions and client responses 80). In some examples, recommendations module 40 accesses recommendation inventory 52 stored in library 28, selects applicable recommendations 92 from recommendation inventory 52 based on the responses and the corresponding questions of overall question set 76, generates final recommendations 96 using applicable recommendations 92, and outputs final recommendations 96. In some examples, assessor 18 can modify applicable recommendations 92 via user interface 26 before final recommendations 96 are generated. In some examples, assessor 18 can score each of the responses and the corresponding questions of overall question set 76 as compliant, partially compliant, or not compliant. In some examples, final recommendations 96 represent action items for improving an information security and/or privacy posture of a client organization. In some examples, each of applicable recommendations 92 can include an indication of high, moderate, or low priority, the indication of high, moderate, or low priority being associated with an industry of a client organization or with a target information security and/or privacy maturity of the client organization. In some examples, each of the responses and the corresponding questions of overall question set 76 is associated with a corresponding one of applicable recommendations 92.

Step 322 can be a final step of process 300. Although illustrated as single steps, it should be understood that each of steps 302-322 can, in other examples, be repeated any number of times in process 300.

Process 300, including steps 306 and 308 for accessing requirement dependencies map 46 and generating dependency-mapped requirements set 64, allows for more consistent information security and/or privacy assessments.

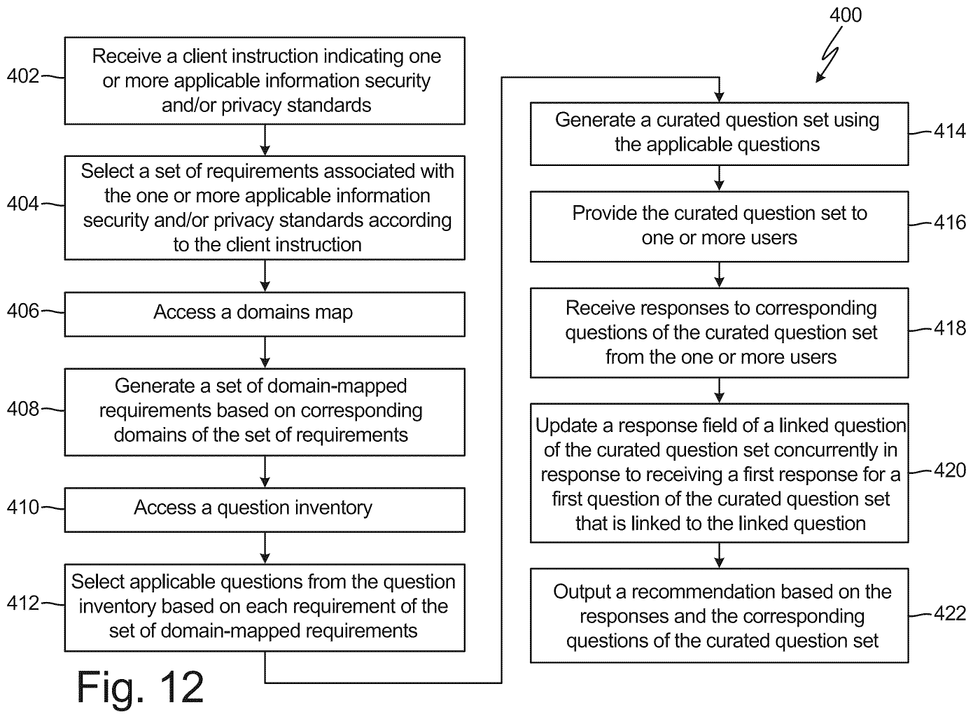

FIG. 12 is a process flowchart showing steps 402-422 of process 400 for generating and administering an information security and/or privacy assessment. As illustrated in FIG. 12, a first step of process 400 is receiving client instruction 56 indicating one or more applicable standards 54 of predefined information security and/or privacy standards 14 (step 402). Client instruction 56 can be received by standards module 30 of GRC tool 12. Each of standards 14 can include corresponding requirements. Standards module 30 can access standards 14 from standards inventory 44 in library 28. At step 404, standards module 30 selects a set of requirements (e.g., requirements set 58) associated with the one or more applicable standards 54 according to client instruction 56.

At step 406, domain mapping module 34 of GRC tool 12 accesses domains map 48 from library 28. Domains map 48 associates the corresponding requirements of standards 14 with one or more domains. In some examples, each of the one or more domains represents a functional and/or decision-making division within an organization. In some examples, each of the one or more domains is generic to each of standards 14. In some examples, domains map 48 includes about 15-20 domains. In some examples, the one or more domains include a GRC strategy domain, a policy management domain, a prioritization and classification of environments domain, a risk management program domain, a security awareness program domain, a third-party management domain, a change management domain, an SDLC domain, a vulnerability management domain (including an asset management domain, an IT asset classification domain, a configuration management domain, a patch management domain, a scanning and penetration testing domain, and a secondary sources domain), an end-point protection/anti-malware domain, a contingency planning domain, a security audit log management domain, an identity and access management domain, a physical security domain, a data governance program domain (including a data discovery classification and labeling domain, a data purging domain, and an encrypt data at-rest and in-transit domain), an infrastructure/network security domain, an incident response domain, and a regular audit domain. At step 408, domain mapping module 34 generates a set of domain-mapped requirements (e.g., domain-mapped requirements set 70) based on corresponding domains of the set of requirements (e.g., requirements set 66) associated with the one or more applicable standards 54 according to domains map 48.

At step 410, operational definition module 36 of GRC tool 12 accesses question inventory 50 from library 28. At step 412, operational definition module 36 selects applicable questions 72 from question inventory 50 based on each requirement of the set of domain-mapped requirements (e.g., domain-mapped requirements set 70). At step 414, operational definition module 36 generates curated overall question set 76 using applicable questions 72. In some examples, question inventory 50 includes operational definitions for the corresponding requirements of standards 14, and overall question set 76 includes a corresponding operational definition for each requirement of the set of domain-mapped requirements (e.g., domain-mapped requirements set 70). In certain examples, overall question set 76 is more specifically overall question set 76′ and includes subset question sets (e.g., domain subset question sets 82A-82n shown in FIG. 7B), each of domain subset question sets 82A-82n corresponding to at least one of the one or more domains. In some such examples, when a same question of overall question set 76′ occurs in multiple ones of domain subset question sets 82A-82n, each iteration of the same question includes an indication of overlap with the multiple ones of domain subset question sets 82A-82n.

At step 416, client response module 38 of GRC tool 12 provides overall question set 76 to one or more users. Client response module 38 can provide overall question set 76 via user interface 26. At step 418, client response module 38 receives client responses 78 to corresponding questions of overall question set 76 from the one or more users. In some examples, the one or more users can indicate that one or more questions in overall question set 76 are inapplicable.

At step 420, client response module 38 updates a response field (e.g., question response field 90C shown in FIG. 8) of a linked question (e.g., question 88C shown in FIG. 8) of overall question set 76 concurrently in response to receiving a first response (e.g., client response 86 shown in FIG. 8) for a first question (e.g., question 88A shown in FIG. 8) of overall question set 76 that is linked to the linked question. In some examples, the first question and the linked question represent a matching question, and the response field of the linked question is updated to include a same response as the first response. In other examples, the first question and the linked question represent opposite questions, and the response field of the linked question is updated to include an opposite response from the first response.

At step 422, recommendations module 40 of GRC tool 12 outputs a recommendation based on the responses and the corresponding questions of overall question set 76 (e.g., linked questions and client responses 80). In some examples, recommendations module 40 accesses recommendation inventory 52 stored in library 28, selects applicable recommendations 92 from recommendation inventory 52 based on the responses and the corresponding questions of overall question set 76, generates final recommendations 96 using applicable recommendations 92, and outputs final recommendations 96. In some examples, assessor 18 can modify applicable recommendations 92 via user interface 26 before final recommendations 96 are generated. In some examples, assessor 18 can score each of the responses and the corresponding questions of overall question set 76 as compliant, partially compliant, or not compliant. In some examples, final recommendations 96 represent action items for improving an information security and/or privacy posture of a client organization. In some examples, each of applicable recommendations 92 can include an indication of high, moderate, or low priority, the indication of high, moderate, or low priority being associated with an industry of a client organization or with a target information security and/or privacy maturity of the client organization. In some examples, each of the responses and the corresponding questions of overall question set 76 is associated with a corresponding one of applicable recommendations 92.

Step 422 can be a final step of process 400. Although illustrated as single steps, it should be understood that each of steps 402-422 can, in other examples, be repeated any number of times in process 400.

Process 400, including steps 406 and 408 for accessing domains map 48 and generating domain-mapped requirements set 70, allows for improved planning, compliance monitoring, and control implementation within a client organization.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A governance, risk, and compliance (GRC) system comprising:
a user interface;
one or more processors; and
computer-readable memory encoded with instructions that, when executed by the one or more processors, cause the GRC system to:
receive a client instruction indicating one or more applicable cybersecurity standards of pre-defined cybersecurity standards, each of the pre-defined cybersecurity standards including corresponding requirements;
select a set of requirements associated with the one or more applicable cybersecurity standards according to the client instruction;
access, from a computer-based library, a domains map that associates the corresponding requirements of the pre-defined cybersecurity standards with one or more domains;
generate a set of domain-mapped requirements based on corresponding domains of the set of requirements associated with the one or more applicable cybersecurity standards according to the domains map;
access a question inventory from the computer-based library;
select applicable questions from the question inventory based on each requirement of the set of domain-mapped requirements;
generate a curated question set using the applicable questions;
provide the curated question set to one or more users via the user interface;
receive responses to corresponding questions of the curated question set from the one or more users;
update a response field of a linked question of the curated question set concurrently in response to receiving a first response for a first question of the curated question set that is linked to the linked question; and
output recommendations based on the responses and the corresponding questions of the curated question set.

2. The GRC system of claim 1, wherein the question inventory includes operational definitions for the corresponding requirements of the pre-defined cybersecurity standards; and
wherein the curated question set includes a corresponding operational definition for each requirement of the set of domain-mapped requirements.

3. The GRC system of claim 1, wherein the curated question set is an overall question set that includes subset question sets, each of the subset question sets corresponding to at least one of the one or more domains.

4. The GRC system of claim 3, wherein when a same question of the overall question set occurs in multiple ones of the subset question sets, each iteration of the same question includes an indication of overlap with the multiple ones of the subset question sets.

5. The GRC system of claim 1, wherein the first question and the linked question represent a matching question and the response field of the linked question is updated to include a same response as the first response.

6. The GRC system of claim 1, wherein the first question and the linked question represent opposite questions and the response field of the linked question is updated to include an opposite response from the first response.

7. The GRC system of claim 1, wherein the instructions, when executed by the one or more processors, further cause the GRC system to:
access a recommendation inventory that is stored in the computer-based library;
select applicable recommendations from the recommendation inventory based on the responses and the corresponding questions of the curated question set;
generate final recommendations using the applicable recommendations; and
output the final recommendations.

8. The GRC system of claim 7, wherein the GRC system is configured such that an assessor can modify the applicable recommendations via the user interface before the final recommendations are generated.

9. The GRC system of claim 7, wherein the final recommendations represent action items for improving an information security and/or privacy posture of a client organization.

10. The GRC system of claim 7, wherein each of the applicable recommendations can include an indication of high, moderate, or low priority, the indication of high, moderate, or low priority being associated with an industry of a client organization or with a target information security and/or privacy maturity of the client organization.

11. The GRC system of claim 7, wherein each of the responses and the corresponding questions of the curated question set is associated with a corresponding one of the applicable recommendations.

12. The GRC system of claim 1, wherein the GRC system is configured such that the one or more users can indicate that one or more questions in the subset question sets are inapplicable.

13. The GRC system of claim 1, wherein the GRC system is configured such that an assessor can score each of the responses and the corresponding questions of the curated question set as compliant, partially compliant, or not compliant.

14. The GRC system of claim 1, wherein each of the one or more domains represents a functional and/or decision-making division within an organization.

15. The GRC system of claim 14, wherein each of the one or more domains is generic to each of the pre-defined cybersecurity standards.

16. The GRC system of claim 1, wherein the domains map includes about 15-20 domains.

17. The GRC system of claim 1, wherein the GRC system is a cloud-based system.

18. A method of generating and administering an information security and/or privacy assessment, the method comprising:
receiving a client instruction indicating one or more applicable cybersecurity standards of pre-defined cybersecurity standards, each of the pre-defined cybersecurity standards including corresponding requirements;
selecting a set of requirements associated with the one or more applicable cybersecurity standards according to the client instruction;
accessing, from a computer-based library, a domains map that associates the corresponding requirements of the pre-defined cybersecurity standards with one or more domains;
generating a set of domain-mapped requirements based on corresponding domains of the set of requirements associated with the one or more applicable cybersecurity standards according to the domains map;
accessing a question inventory from the computer-based library;
selecting applicable questions from the question inventory based on each requirement of the set of domain-mapped requirements;
generating a curated question set using the applicable questions;
providing the curated question set to one or more users via a user interface;
receiving responses to corresponding questions of the curated question set from the one or more users;
updating a response field of a linked question of the curated question set concurrently in response to receiving a first response for a first question of the curated question set that is linked to the linked question; and
outputting recommendations based on the responses and the corresponding questions of the curated question set.

19. The method of claim 18, wherein the curated question set is an overall question set that includes subset question sets, each of the subset question sets corresponding to at least one of the one or more domains; and
wherein providing the curated question set to one or more users further includes providing each of the subset question sets to ones of the one or more users that are associated with a corresponding domain of a respective one of the subset question sets.

20. A system for generating and administering an information security and/or privacy assessment, the system comprising:
a user interface;
one or more processors; and
computer-readable memory encoded with instructions that, when executed by the one or more processors, cause the system to:
receive a client instruction indicating one or more applicable information security and/or privacy standards of pre-defined information security and/or privacy standards, each of the pre-defined information security and/or privacy standards including corresponding requirements;
select a set of requirements associated with the one or more applicable information security and/or privacy standards according to the client instruction;
access, from a computer-based library, a domains map that associates the corresponding requirements of the pre-defined information security and/or privacy standards with one or more domains;
generate a set of domain-mapped requirements based on corresponding domains of the set of requirements associated with the one or more applicable information security and/or privacy standards according to the domains map;
access a question inventory from the computer-based library;
select applicable questions from the question inventory based on each requirement of the set of domain-mapped requirements;
generate a curated question set using the applicable questions;
provide the curated question set to one or more users via the user interface;
receive responses to corresponding questions of the curated question set from the one or more users;
update a response field of a linked question of the curated question set concurrently in response to receiving a first response for a first question of the curated question set that is linked to the linked question; and
output recommendations based on the responses and the corresponding questions of the curated question set.
